(19) United States
(12) Patent Application Publication
(10) Pub. No.: US 2014/0350962 A1
(43) Pub. Date: Nov. 27, 2014

(54) GENERATING REVIEWS OF MEDICAL IMAGE REPORTS

(71) Applicant: Clear Review, Inc., Seattle, WA (US)

(72) Inventor: Jeffrey David Robinson, Seattle, WA (US)

(73) Assignee: Clear Review, Inc., Seattle, WA (US)

(21) Appl. No.: 13/901,391

(22) Filed: May 23, 2013

(51) Int. Cl. G06F 19/00

(52) U.S. Cl. CPC G06F 19/3487
USPC 705/3

(57) ABSTRACT

Embodiments are directed towards generating reviews of exams. An exam of interest (EOI) may be anonymized and blinded. N−1 anonymized and blinded foil exams may be selected from an exam database, where N is an integer greater than 1. An anonymized and blinded exam set may be generated for review, where the exam set includes the EOI and the selected foil exams. The exam set may be provided to a reviewer. The reviewer may not be able to discriminate between the EOI and the foil exams. An assessment metric may be generated based on a review of each exam in the exam set. An assessment metric set may be generated, where the assessment metric set includes each generated assessment metric. A report may be generated based on the assessment metric set. The report may indicate a reviewer determination of an overall quality of the EOI. The report may indicate a consistency score for the reviewer, based at least on the reviews of the foil exams. The exam database may be updated based on at least one of the EOI, the assessment metric set, or the consistency score.

### TECHNICAL FIELD

The present invention relates generally to reviews of exams, and more particularly, but not exclusively, to generating reviews of anonymized and blinded exams in an exam set, where the exam set includes at least an exam of interest.

### BACKGROUND

To diagnosis various illnesses of their patients, medical professionals such as doctors, nurses, nurse practitioners, physician assistants, and medical technicians, often prescribe exams. Some of these exams may include a report analyzing the results of various blood tests in comparison to “normal” values. Other exams may include one or more medical images of at least a portion of a patient's body and a report diagnosing the potential presence of a disease or physical injury. The medical images may be created by a medical professional with a variety of different medical apparatuses that may utilize one or more of X-rays, Computed Tomography (CT), Magnetic Resonance Imaging (MRI), Positron Emission Tomography (PET), Ultrasound, Thermograph, and the like. Although medical images are often created by a medical technician, the reports that analyze these medical images are typically created by a specialized medical professional, such as a radiologist.

A medical exam that includes a report on medical images that inconclusively (or incorrectly) diagnoses an illness or physical injury is often the source of disagreement in medical malpractice litigation. Typically, an expert witness, e.g., another radiologist, is asked to provide an opinion on whether the prior medical professionals' diagnosis met a reasonable standard of care, or fell below that standard of care. Currently, the outcome of malpractice litigation often depends upon a jury's subjective belief in the testimony of one or more expert witnesses that have reviewed a medical exam at issue.

Unfortunately, a review of a medical exam in the context of litigation often introduces various forms of bias which may affect the expert witness' judgment. For instance, since the medical exam is subject to litigation, this fact may introduce a “framing bias” for the expert witness. Also, the expert witness may have access to the patient's outcome, such as the patient ultimately succumbing to cancer. In this case, an expert witness may consciously or unconsciously be inclined to focus on minute potential signs of cancer in a medical image that otherwise might not normally be considered under a reasonable standard of care. This “outcome bias” may also affect the expert witness' judgment of the medical exam's analysis. Additionally, the expert witness may also suffer from “hindsight bias” because the expert witness may have access to other medical information not available at the time the medical exam was initially analyzed. Similarly, once a subtle anomaly is identified in a medical image for the expert witness, it may be difficult to “un-see” the anomaly during their subsequent review of the initial medical exam. This “learning effect” may further bias the expert witness' judgment on whether the prior medical professional's initial diagnosis met or fell below the standard of care.

Furthermore, in addition to the legal system, it is often difficult for medical clinics, hospitals, educational institutions, medical boards, and the like, to evaluate the ability of a medical professional to analyze and diagnose medical images.

Thus, it is with respect to these considerations and others that the present invention has been made.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Detailed Description, which is to be read in association with the accompanying drawings, wherein:

FIG. 1 illustrates a system environment in which various embodiments may be implemented;

FIG. 2 shows a server device that may be included in various embodiments;

FIG. 3 illustrates a client device that may be included in various embodiments;

FIG. 4 illustrates a logical flow diagram generally showing one embodiment of an overview process for generating reviews of exams;

FIG. 5 illustrates a logical flow diagram generally showing one embodiment of a process for anonymizing and blinding an exam of interest;

FIG. 6 illustrates a logical flow diagram generally showing one embodiment of a process for generating a report for an exam set based on an assessment metric set;

FIG. 7 illustrates a logical flow diagram generally showing one embodiment of a process for updating an exam database based on an exam of interest and an assessment metric set;

FIG. 8 illustrates a non-exhaustive example of an image included in an exam;

FIG. 9 illustrates a non-exhaustive example of a report included in an exam; and

FIG. 10 illustrates a non-exhaustive example of a form that enables a reviewer to review each exam in a relatively standardized manner.

### DETAILED DESCRIPTION

Various embodiments now will be described more fully hereinafter with reference to the accompanying drawings, which form a part hereof, and which show, by way of illustration, specific embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media, or devices. Accordingly, the various embodiments may take the form of an entirely hardware embodiment, an entirely software embodiment, or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example embodiments, the following terms are also used herein according to the corresponding meaning, unless the context clearly dictates otherwise.

The term “ex-ante determination” as used herein may include any determination determined prior to, or previously to the determination of an ex post facto determination.

The term “ex post facto determination” as used herein may include any determination determined post, or after the determination of an ex-ante determination.

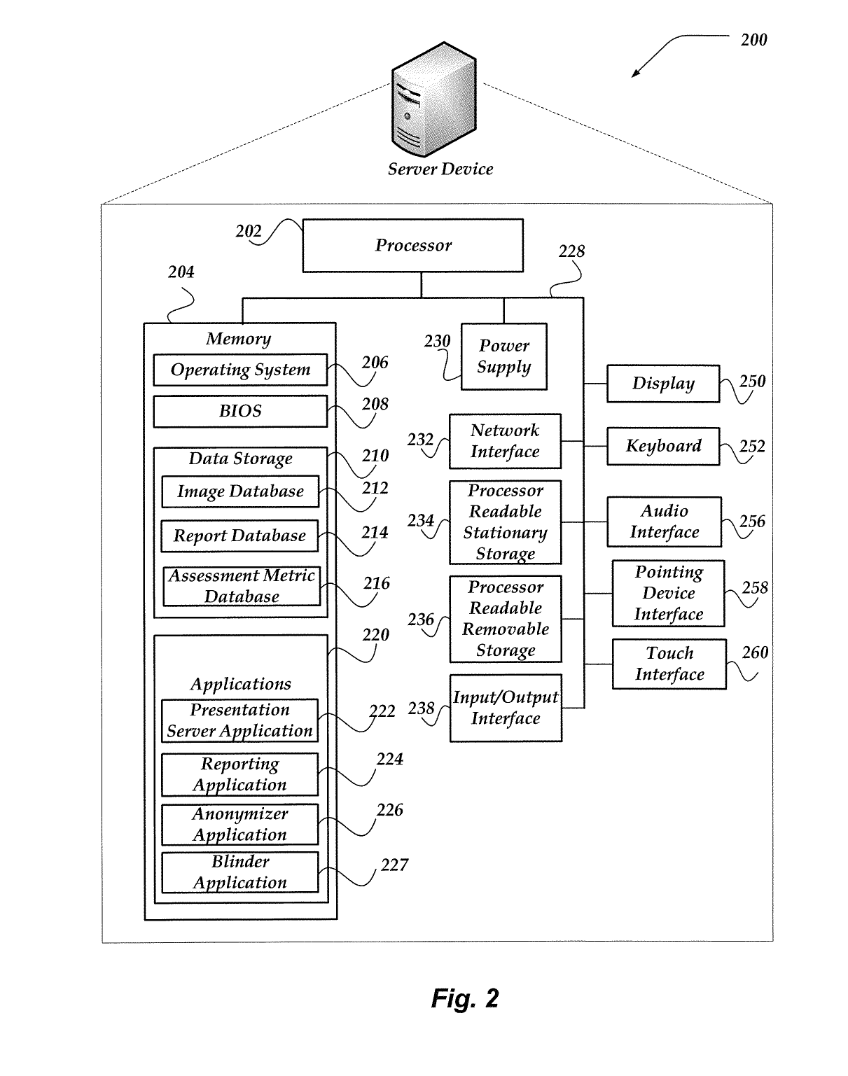

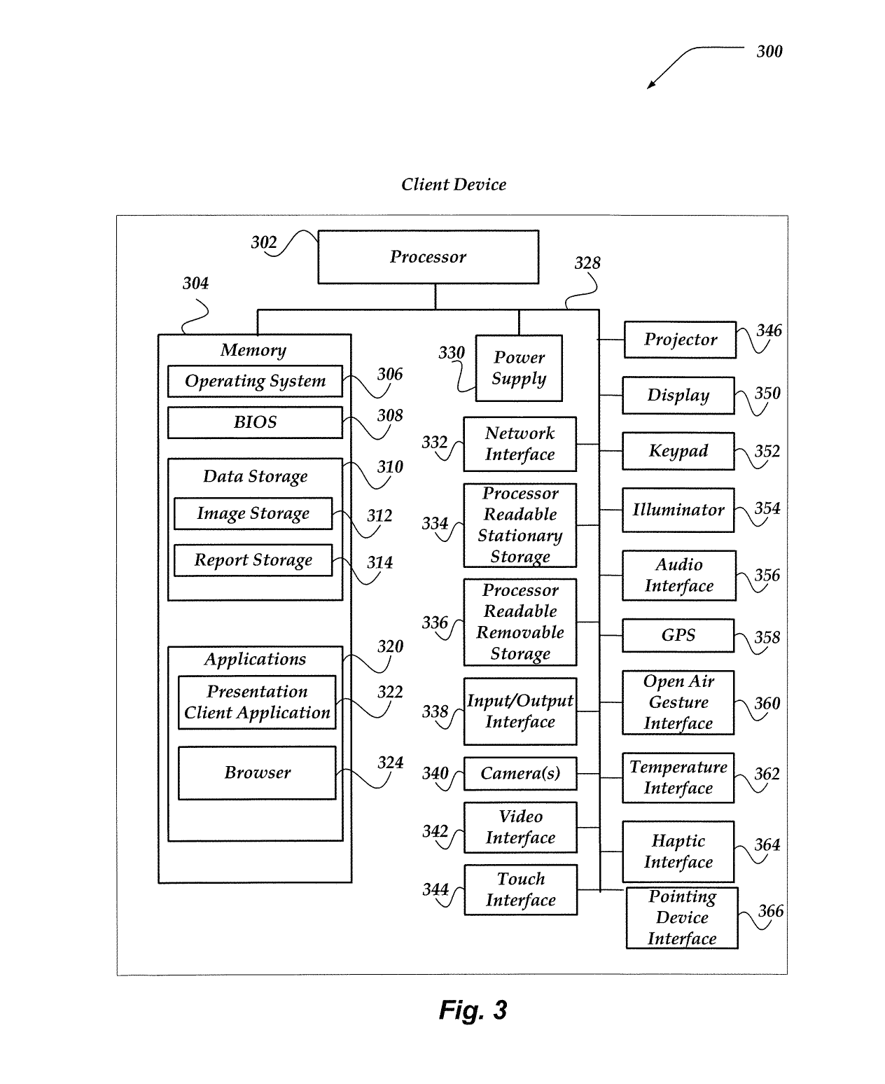

The term “examiner” as used herein may include any determiner that determines an ex-ante determination. In at least one embodiment, an examiner may include any determiner that determines a determination, where the determination is included in a report and where the report is included in an exam. In some embodiments, an examiner may be an individual. In at least one embodiment, an examiner may be an examining physician. In at least one embodiment, an examiner may be a radiologist. In some embodiments, an examiner may be a device, such as server device 200 of FIG. 2 or client device 300 of FIG. 3.

The term “reviewer” as used herein may include any determiner that determines an ex post facto determination. In at least one embodiment, a reviewer may include any determiner that determines a determination, during the review of an exam. In some embodiments, a reviewer may be an individual. In at least one embodiment, a reviewer may be an expert. In at least one of the various embodiments, a reviewer may be an expert witness. In at least one embodiment, a reviewer may be a radiologist. In some embodiments, a reviewer may be a device, such as server device 200 of FIG. 2 or client device 300 of FIG. 3.

The term “time of examination” as used herein may include the time at which an ex-ante determination, included in a report, where the report is included in an exam, was determined. In at least one embodiment, the time of examination occurs prior to, or before the time of review.

The term “time of review” as used herein may include the time at which an ex post facto determination, indicated in an assessment metric based on at least a reviewed exam, was determined. In at least one embodiment, the time of review occurs post, or after the time of examination.

The term “subject” as used herein may include any subject for which a record or exam is associated with. In some embodiments, a subject may be a patient. In at least one of the various embodiments, a subject may be a litigant.

The term “record” as used herein may include any record that is associated with a subject. A record may include at least one dataset. In some embodiments, a record may be a medical record, associated with a patient. A record may include an exam. In at least one embodiment, a record may include a medical history or a portion of a medical history of a patient. In at least one of the various embodiments, a record may be associated with an exam if the record and the exam are associated with the same subject, such as the same patient. In some embodiments, a record may be associated with an exam if the record was provided to the examiner at, or before, the time of examination. In at least one embodiment, a record may include metadata.

The term “exam” as used herein may include any exam that includes at least one dataset and at least one corresponding report. In at least one embodiment, the dataset may include at least one image, where the at least one report corresponds to the at least one image. The exam may be a medical exam, although the invention is not to be construed as so limiting. The exam may be associated with a subject, such as a patient. The at least one image may be a radiology image. In at least one embodiment, the report may include at least one ex-ante determination based on at least the corresponding dataset, such as a corresponding image. In some embodiments, at least one record may be associated with the exam. The at least one record may contain at least one other dataset. In at least one embodiment, the other dataset may be provided to an examiner at, or before, the time of the examination. The at least one record may be a medical record. The medical record may be a medical record associated with the subject of the exam. The medical record may include at least one medical dataset pertaining to the patient, where the at least one medical dataset may be provided to the examiner at the time of examination. In at least one of the various embodiments, the ex-ante determination may be based on at least the associated record. In some embodiments, an ex-ante determination may include at least a diagnosis. In at least one embodiment, an ex-ante determination may be determined by an examiner. The examiner may be a medical professional, such as an examining physician, radiologist, and the like. In some embodiments, the examiner may be provided each record associated with the exam contemporaneous with or prior to the time of examination. In at least one embodiment, an exam may include metadata. In some embodiments, an image included in an exam may include metadata. A report included in an exam may include metadata. In at least one embodiment, at least one included image is a Digital Imaging and Communications in Medicine (DICOM) image.

The term “radiology image” as used herein may include any image used to visualize a biological sample, specimen, or individual. Imaging technologies employed to generate a radiology image include, but are not limited to medical imaging technologies such as radiography, including both traditional and digital X-rays, fluoroscopy, teleradiology, ultrasound, computed tomography (CT), nuclear medicine, positron emission tomography (PET), thermography, magnetic resonance imaging (MRI), and the like. Although various embodiments described herein may be directed towards exams including radiology images, the invention is not to be construed as being limited to exams including radiology images, but may include any type of image, including images of non-biological material.

The term “exam of interest” (EOI) as used herein may include any exam for which a review of the EOI is desired. In at least one embodiment, at least one ex-ante determination included in the EOI may be at issue. In some embodiments, the ex-ante determination at issue may be a diagnosis. In at least one embodiment, the ex-ante determination may be at issue in the context of litigation, such as medical malpractice litigation.

The term “assessment metric” as used herein may include at least one assessment metric element. An assessment metric may be based on a review of an exam. An assessment metric element may be based on a review of an exam. In at least one embodiment, an assessment metric may correspond to the reviewed exam for which the assessment metric is based on. In some embodiments, the at least one assessment metric element may correspond to a reviewed exam. In at least one embodiment, an assessment metric element may indicate at least one ex post facto determination based on the review of the exam. In some embodiments, an assessment metric element may include an overall exam quality element. An overall quality element may indicate an ex post facto determination regarding a quality of at least an ex-ante determination included in the reviewed exam. In at least one embodiment, the overall quality element may indicate an ex post facto determination regarding whether an ex-ante determination included in the reviewed exam either met a standard, or alternatively, fell below the standard. In at least one embodiment, a standard may be a standard of care. In some embodiments, a standard may be a community standard. In some embodiment, a standard may be a local standard. In at least one embodiment, a standard may be either a national or global standard. In some embodiments, the ex-ante determination included in the reviewed exam may be a diagnosis. In at least one embodiment, at least one ex post facto determination indicated by an assessment metric element may be determined by a reviewer. In at least one embodiment, the reviewer may be an expert on the subject matter of the reviewed exam. In some embodiments, the expert may be an expert witness. In at least one embodiment, an assessment metric may include a plurality of assessment metric elements, wherein each included assessment metric element indicates at least one ex post facto determination regarding the reviewed exam. An assessment metric may include an identifier, such as a number, where the number is associated with the corresponding reviewed exam. For instance, an exam may be associated with a medical record number (MRN). In some embodiments, a corresponding assessment metric may include the MRN associated with the reviewed exam. In at least one embodiment, the MRN may be a random MRN. In some embodiments, the plurality of assessment metric elements may be arranged as an ordered list. In at least one embodiment, the assessment metric may be an n-tuple.

The term “foil exam” as used herein may include any exam. In some embodiments, a foil exam may include an exam for which an assessment metric has been previously generated. In at least one embodiment, the previously generated assessment metric may be based on a previous review of the foil exam. In at least one embodiment, at least one previously determined assessment metric may correspond to a foil exam. In some embodiments, a plurality of reference reviews may correspond to a foil exam.

The term “data environment” as used herein may include the totality of information available to a determiner, such as an examiner or a reviewer, pertaining to a particular subject, such as a patient, at the time of a particular determination, such as an ex-ante determination or an ex post facto determination, where the determination is determined during an examination or review. The data environment may include datasets, or portions of datasets, such as records, exams, images, histories, and the like. Additionally, the data environment may include a simulated user interface that is provided to a reviewer, such as picturing, archiving, and communication system that was available to the examiner for initially generating the exam.

The term “anonymize” as used herein may include a process by which all identifying information is removed, deleted, masked, redacted, destroyed, stripped, or otherwise made unavailable. In at least one embodiment, anonymize may include a process by which a collection of data is stripped of all information which would allow the identification of the source of the data. In some embodiments, an image may be anonymized. In some embodiments, a report may be anonymized. In at least one embodiment, a record may be anonymized. In some embodiments, an exam may be anonymized if all included datasets, such as images, have been anonymized, if all included reports have been anonymized, and if all associated records have been anonymized. In some embodiments, a subject associated with an anonymized exam cannot be identified. Likewise, in some embodiments, a subject associated with an anonymized record, image, or report cannot be identified. In at least one embodiment, anonymize may include a de-identification process. In some embodiments, anonymize may include a process by which all Protected Health Information (PHI) elements are eliminated or manipulated with the purpose of preserving the anonymity of a patient associated with the PHI. In at least one embodiment, anonymize may include a Safe Harbor Method, where the Safe Harbor Method is associated with the Health Insurance Portability and Accountability Act (HIPAA) privacy rules. In some embodiments, and anonymized exam, report, image, record, or other dataset may satisfy the requirements of the HIPAA safe harbor. A non-exhaustive list of examples of identifying information that may be removed, deleted, masked, redacted, destroyed, stripped, or otherwise made unavailable by an anonymizing process include: names, geographical identifiers smaller than a state, dates related to a subject, phone numbers, fax numbers, email addresses, social security numbers, medical record numbers, health insurance beneficiary numbers, account numbers, certificate/license plate numbers, vehicle identifiers, device identifiers, Web Uniform Resource Locators, Internet Protocol addresses, biometric identifiers, such as finger, retinal, and voice prints, face photographs, and any other unique identifiers. In some of the various embodiments, anonymize may include a process that removes, deletes, masks, redacts, destroys, strips, or otherwise makes unavailable identifying metadata associated with an exam, dataset, image, report, or the like. In at least one embodiment, anonymizing a report may include standardizing the report. In at least one embodiment, standardizing a report may include performing an optical scanning process on the report. In some embodiments, standardizing a report may include performing an Optical Character Recognition (OCR) process on the report. In at least one embodiment, standardizing the report may include providing non-identifying information, included in the report, in a predetermined standardized format.

The term “blind” as used herein may include a process to update with provided data. In some embodiments, an image may be blinded. In some embodiments, a report may be blinded. In at least one embodiment, a record may be blinded. In some embodiments, an exam may be blinded if all included datasets, such as images, have been blinded, if all included reports have been blinded, and if all associated records have been blinded. In some embodiments, a subject associated with a blinded exam cannot be identified. Likewise, in some embodiments, a subject associated with a blinded record, image, or report cannot be identified. In at least one embodiment, blind may include an update with data based on at least a random process or pseudo-random process, such as a process employed by a random number generator. In at least one embodiment, blinding an exam, image, report, or record may include updating the exam, image, report, or record to include a provided random number, such as a random medical record number (MRN). In at least one embodiment, blinding an exam, image, report, or record may include updating the exam, image, report, or record to include a provided date, such as a date based at least on a random process or pseudo-random process. In at least one embodiment, the provided date may include an examination date offset by a randomly determined offset. In at least one embodiment, a randomly determined offset may be applied to at least one of a month, a year, or a day. In at least one embodiment, anonymizing a report may include standardizing the report. In at least one embodiment, blinding an exam, image, report, or record may include updating the exam, image, report, or record to include provided metadata.

The following briefly describes embodiments in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments are directed towards generating reviews of previously created exams. In at least one of the various embodiments, a plurality of exams may be modified to be anonymous, blinded, and accessible as foil exams in a database. In at least one embodiment, an exam of interest (EOI) may be modified to be anonymous and blinded. At least one foil exam may be selected based at least in part on the EOI. In at least one of the various embodiments, an exam set that included the at least one foil exam and the modified EOI may be generated. A review of the exam set by a reviewer may be enabled, where the reviewer provides assessment metric that correspond to the at least one foil exam and the modified EOI. In at least one embodiment, a report for the exam set may be generated, where the report is based on at least the assessment metrics.

In at least one of the various embodiments, at least one foil exam was previously reviewed by at least one other reviewer. In at least one embodiment, each element of an assessment metric that corresponds to a foil exam may be compared to another element of another assessment metric that was previously provided by another review of the foil exam. A consistency score for the review may be determined, where the consistency score may be based on at least each comparison. In at least one of the various embodiments, an assessment metric that corresponds to a foil exam may be compared to another assessment metric that was previously provided by another reviewer of the foil exam. A consistency score for the review may be determined, where the consistency score may be based on at least each comparison.

In at least one of the various embodiments, the modified EOI may be added as another foil exam that is accessible in the database. In at least one embodiment, at least one foil exam and the modified EOI may be tagged with at least one identifier. A foil exam and the modified EOI may be annotated.

In at least one embodiment, the invention may simulate a data environment for the review of an exam. The simulated data environment may be based on a data environment associated with the EOI and at the time of examination. In at least one embodiment, each dataset relevant to the EOI, including records, images, reports, histories, and the like that was provided to the examiner at the time of examination may be provided to the reviewer at the time of review. In some embodiments, the reviewer may be provided with a predetermined limited amount of time in which to review each exam in the exam set. The predetermined limited amount of time may be based on at least a window of time spanning the examination of the EOI. In at least one embodiment, a data environment may be an adaptive data environment.

In at least one embodiment, data, including datasets and other information, not provided to the examiner at, or before, the time of examination, may be screened or filtered from the reviewer at the time of review. Accordingly, in at least one embodiment, the data environment at the time of review of the EOI simulates the data environment at the time of examination of the EOI. A data environment associated with each of the exams in the exam set may be simulated in a similar fashion.

Because the reviewer reviews each exam in the exam set and each exam is anonymized and blinded, the reviewer lacks knowledge of which exam in the exam set is the EOI and which exams in the exam set are foil exams. Furthermore, because the data environment at the time of examination is simulated at the time of review, the reviewer is not privileged with information, or hindsight, not available to the examiner at the time of examination. Thus, bias often associated with an ex post facto determination determined at the time of review is minimized. In at least one embodiment, the generated report includes at least one assessment metric element, where the assessment metric element may be based on the review of the EOI. Accordingly, in at least one embodiment, the generated report may indicate an ex post facto determination regarding the EOI and based on a review by a reviewer, where the reviewer bias is minimal. In at least one embodiment, a duty of care provided by a medical professional that initially generated the EOI may be determined. IN at least on of the various embodiments, a competency of a medical professional to review a plurality of exams may be determined.

Furthermore, in at least one embodiment, the generated report may be based on an least one assessment metric for each of the foil exams in the exam set, where the assessment metric is based on the reviewer's review of the foil exam. In some embodiments, the assessment metric for each of the foil exams may indicate a consistency of the reviewer in regards to determining ex post facto determinations regarding exams in general.

In at least one embodiment, each foil exam included in the exam set may correspond with at least one other assessment metric. In some embodiments, the at least one other assessment metric may have been previously generated. In some embodiments, the at least one other assessment metric may have been generated based on another review by at least one other reviewer, where the other review occurred previous to the reviewer's review. The at least one other assessment metric may indicate a standard associated with at least one ex-ante determination included in the reviewed exam. In at least one of the various embodiments, a plurality of other assessment metrics may correspond with each foil exam. Each of the assessment metrics included in the plurality of other assessment metrics may have been previously generated based on another previous review by at least a reviewer from a plurality of other reviewers. In at least one embodiment, the plurality of other assessment metrics generated based on a plurality of other previous reviews may indicate a standard associated with at least one ex-ante determination included in the reviewed exam.

In at least one embodiment, for each foil exam in the exam set, the assessment metric corresponding to the foil exam from the assessment metric set may be selected. In at least one embodiment, for each selected foil exam assessment metric, the foil exam assessment metric may be compared to the at least one other assessment metric, previously generated and corresponding with the foil exam. In at least one of the various embodiments, a consistency score based on each comparison of the selected foil exam metric to the at least one other previously generated foil exam assessment metric may be determined.

In some embodiments, the determined consistency score may indicate a consistency of the reviewer to determine ex post facto determinations regarding exams in general. In at least one of the various embodiments, the consistency score may indicate the consistency of the reviewer to determine, ex post facto, if an ex-ante determination included in an exam either met a standard or alternatively, fell below the standard. In some embodiments, the standard may be a standard of care. In at least one embodiment, the standard may be a community standard. In at least one of the various embodiments, the consistency score may indicate a level of confidence or reliability in the assessment metrics generated and based on the review for each exam in the exam set. In at least one embodiment, the generated report may include the determined consistency score, where the consistency score may indicate an overall reliability of the reviewer.

At least one embodiment of the present invention may include an exam database. In at least one embodiment, the exam database may include at least one of an image database, a report database, or an assessment metric database. In some embodiments, the exam database may include a record database. In at least one of the various embodiments, each exam, image, report, or record stored in the exam database has been anonymized and blinded. In at least one embodiment, at least one of the exams in the exam database may be an annotated exam. In at least one embodiment, each exam, image, report, and record stored in the database may be compliant with the HIPAA privacy rules.

In at least one embodiment, foil exams may be selected from the exam database. In some embodiments, the exam database may be updated to include at least the anonymized and blinded EOI. In at least one embodiment, the exam database may be updated to include the assessment metric generated based on the reviewer's review of the EOI. In at least one of the various embodiments, after the EOI and the corresponding assessment metric have been included in the exam database, the EOI may be selected as a foil exam to be included in another exam set for another review of another EOI.

In at least one embodiment, the exam database may be updated to include at least one of the assessment metrics generated based on the reviewer's review of the foil exams. In at least one of the various embodiments, the number of exams in the exam database increases as more EOIs are provided to the various embodiments. In at least one embodiment, the number of previous reviews for each of the exams in the database increases as more exam sets are reviewed by reviewers. Accordingly, the size and diversity of the exam database may increase over time. In some embodiments, as the size and diversity of the exam database increases, the standards indicated by the corresponding assessment metric included in the exam database may become statistically more significant.

Furthermore, in at least one embodiment, an estimate of a standard, such as a community standard, estimated by the exam database may become more accurate as the size and diversity of the exam database increases. In at least one of the various embodiments, the community may be statistically determined by the plurality of reviewers reviewing exams in the exam database. In some embodiments, the exam database may be updated to include the determined consistency score for a reviewer. In some embodiments, the database may track the reliability of at least one of the plurality of reviewers contributing to exam reviews.

### Illustrative Operating Environment

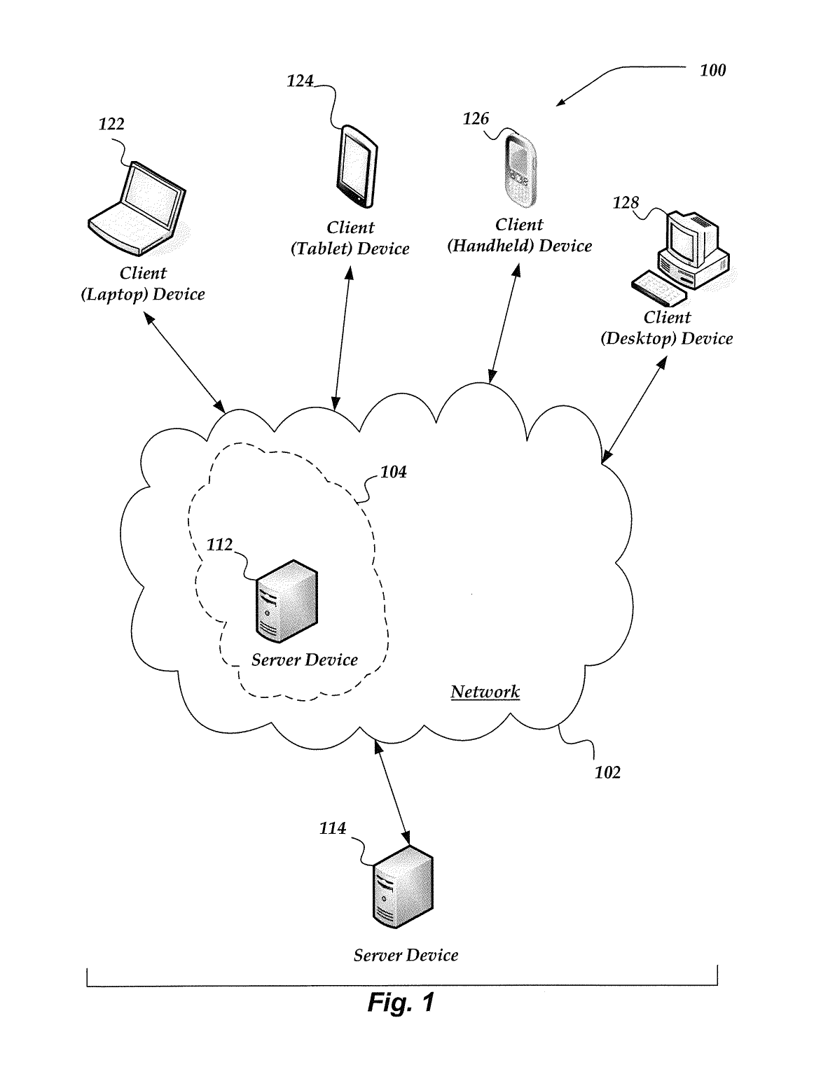

FIG. 1 shows components of an environment in which various embodiments may be practiced. Not all of the components may be required to practice the various embodiments, and variations in the arrangement and type of the components may be made without departing from the spirit or scope of the various embodiments.

In at least one embodiment, cloud network 102 enables one or more network services for a user based on the operation of corresponding arrangement 104 of virtually any type of networked computing device. As shown, the networked computing devices may include server device 112. Although not shown, one or more client devices may be included in cloud network 102 in one or more arrangements to provide one or more network services to a user. Also, these arrangements of networked computing devices may or may not be mutually exclusive of each other.

Additionally, the user may employ a plurality of virtually any type of wired or wireless networked computing devices to communicate with cloud network 102 and access at least one of the network services enabled by one or more of arrangements, including arrangement 104. These networked computing devices may include server device 114, laptop client device 122, tablet client device 124, handheld client device 126, desktop client device 120, and the like. Although not shown, in various embodiments, the user may also employ notebook computers, desktop computers, microprocessor-based or programmable consumer electronics, network appliances, mobile telephones, smart telephones, pagers, radio frequency (RF) devices, infrared (IR) devices, Personal Digital Assistants (PDAs), televisions, integrated devices combining at least one of the preceding devices, and the like.

One embodiment of a client device is described in more detail below in conjunction with FIG. 3. Generally, client devices may include virtually any substantially portable networked computing device capable of communicating over a wired, wireless, or some combination of wired and wireless network.

In various embodiments, network 102 may employ virtually any form of communication technology and topology. For example, network 102 can include local area networks Personal Area Networks (PANs), (LANs), Campus Area Networks (CANs), Metropolitan Area Networks (MANs) Wide Area Networks (WANs), direct communication connections, and the like, or any combination thereof. On an interconnected set of LANs, including those based on differing architectures and protocols, a router acts as a link between LANs, enabling messages to be sent from one to another. In addition, communication links within networks may include virtually any type of link, e.g., twisted wire pair lines, optical fibers, open air lasers or coaxial cable, plain old telephone service (POTS), wave guides, acoustic, full or fractional dedicated digital communication lines including T1, T2, T3, and T4, and/or other carrier and other wired media and wireless media. These carrier mechanisms may include E-carriers, Integrated Services Digital Networks (ISDNs), universal serial bus (USB) ports, Firewire ports, Thunderbolt ports, Digital Subscriber Lines (DSLs), wireless links including satellite links, or other communications links known to those skilled in the art. Moreover, these communication links may further employ any of a variety of digital signaling technologies, including without limit, for example, DS-0, DS-1, DS-2, DS-3, DS-4, OC-3, OC-12, OC-48, or the like. Furthermore, remotely located computing devices could be remotely connected to networks via a modem and a temporary communication link. In essence, network 102 may include virtually any communication technology by which information may travel between computing devices. Additionally, in the various embodiments, the communicated information may include virtually any kind of information including, but not limited to processor-readable instructions, data structures, program modules, applications, raw data, control data, archived data, video data, voice data, image data, text data, and the like.

Network 102 may be partially or entirely embodied by one or more wireless networks. A wireless network may include any of a variety of wireless sub-networks that may further overlay stand-alone ad-hoc networks, and the like. Such sub-networks may include mesh networks, Wireless LAN (WLAN) networks, Wireless Router (WR) mesh, cellular networks, pico networks, PANs, Open Air Laser networks, Microwave networks, and the like. Network 102 may further include an autonomous system of intermediate network devices such as terminals, gateways, routers, switches, firewalls, load balancers, and the like, which are coupled to wired and/or wireless communication links. These autonomous devices may be operable to move freely and randomly and organize themselves arbitrarily, such that the topology of network 102 may change rapidly.

Network 102 may further employ a plurality of wired and wireless access technologies, e.g., 2nd (2G), 3rd (3G), 4th (4G), 5^{th} (5G) generation wireless access technologies, and the like, for mobile devices. These wired and wireless access technologies may also include Global System for Mobile communication (GSM), General Packet Radio Services (GPRS), Enhanced Data GSM Environment (EDGE), Code Division Multiple Access (CDMA), Wideband Code Division Multiple Access (WCDMA), Long Term Evolution Advanced (LTE), Universal Mobile Telecommunications System (UMTS), Orthogonal frequency-division multiplexing (OFDM), Wideband Code Division Multiple Access (W-CDMA), Code Division Multiple Access 2000 (CDMA2000), Evolution-Data Optimized (EV-DO), High-Speed Downlink Packet Access (HSDPA), IEEE 802.16 Worldwide Interoperability for Microwave Access (WiMax), ultra wide band (UWB), user datagram protocol (UDP), transmission control protocol/Internet protocol (TCP/IP), any portion of the Open Systems Interconnection (OSI) model protocols, Short Message Service (SMS), Multimedia Messaging Service (MMS), Web Access Protocol (WAP), Session Initiation Protocol/Real-time Transport Protocol (SIP/RTP), or any of a variety of other wireless or wired communication protocols. In one non-limiting example, network 102 may enable a mobile device to wirelessly access a network service through a combination of several radio network access technologies such as GSM, EDGE, SMS, HSDPA, and the like.

One embodiment of server device 112 is described in more detail below in conjunction with FIG. 2. Briefly, however, server device 112 includes virtually any network device capable of providing services to a client device. In some embodiments, server device 112 may generate a report based on reviews of exams. Devices that may be arranged to operate as server device 112 include various network devices, including, but not limited to personal computers, desktop computers, multiprocessor systems, microprocessor-based or programmable consumer electronics, network PCs, server devices, network appliances, and the like.

Although FIG. 1 illustrates server device 112 as a single computing device, the invention is not so limited. For example, one or more functions of server device 112 may be distributed across one or more distinct network devices. Moreover, server device 112 is not limited to a particular configuration. Thus, in one embodiment, server device 112 may contain a plurality of network devices. In another embodiment, server device 112 may contain a plurality of network devices that operate using a master/slave approach, where one of the plurality of network devices of server device 112 operates to manage and/or otherwise coordinate operations of the other network devices. In other embodiments, server device 112 may operate as a plurality of network devices within a cluster architecture, a peer-to-peer architecture, and/or even within a cloud architecture. Thus, the invention is not to be construed as being limited to a single environment, and other configurations, and architectures are also envisaged.

### Illustrative Network Device

FIG. 2 shows one embodiment of server device 200 that may be included in a system implementing the invention. Server device 200 may include many more or less components than those shown in FIG. 2. However, the components shown are sufficient to disclose an illustrative embodiment for practicing the present invention. Server device 200 may represent, for example, one embodiment of at least one of server device 112 or 114 of FIG. 1.

As shown in the figure, server device 200 may include a processor 202 in communication with a memory 204 via a bus 228. server device 200 may also include a power supply 230, network interface 232, audio interface 256, display 250, keyboard 252, input/output interface 238, processor-readable stationary storage device 234, processor-readable removable storage device 236, and pointing device interface 258. Power supply 230 provides power to server device 200.

Network interface 232 may include circuitry for coupling server device 200 to one or more networks, and is constructed for use with one or more communication protocols and technologies including, but not limited to, protocols and technologies that implement any portion of the Open Systems Interconnection model (OSI model), GSM, CDMA, time division multiple access (TDMA), UDP, TCP/IP, SMS, MMS, GPRS, WAP, UWB, WiMax, SIP/RTP, or any of a variety of other wired and wireless communication protocols. Network interface 232 is sometimes known as a transceiver, transceiving device, or network interface card (NIC). Server device 200 may optionally communicate with a base station (not shown), or directly with another computing device.

Audio interface 256 is arranged to produce and receive audio signals such as the sound of a human voice. For example, audio interface 256 may be coupled to a speaker and microphone (not shown) to enable telecommunication with others and/or generate an audio acknowledgement for some action. A microphone in audio interface 256 can also be used for input to or control of server device 200, for example, using voice recognition.

Display 250 may be a liquid crystal display (LCD), gas plasma, electronic ink, light emitting diode (LED), Organic LED (OLED) or any other type of light reflective or light transmissive display that can be used with a computing device. Display 250 may be a handheld projector or pico projector capable of projecting an image on a wall or other object.

Server device 200 also may also comprise input/output interface 238 for communicating with external devices not shown in FIG. 2. Input/output interface 238 can utilize one or more wired or wireless communication technologies, such as USB™, Firewire™, WiFi, WiMax, Thunderbolt™, Infrared, Bluetooth™, Zigbee™, serial port, parallel port, and the like.

Human interface components can be physically separate from server device 200, allowing for remote input and/or output to server device 200. For example, information routed as described here through human interface components such as display 250 or keyboard 252 can instead be routed through the network interface 232 to appropriate human interface components located elsewhere on the network. Human interface components can include any component that allows the computer to take input from, or send output to, a human user of a computer.

Memory 204 may include RAM, ROM, and/or other types of memory. Memory 204 illustrates an example of computer-readable storage media (devices) for storage of information such as computer-readable instructions, data structures, program modules or other data. Memory 204 may store BIOS 208 for controlling low-level operation of server device 200. The memory may also store operating system 206 for controlling the operation of server device 200. It will be appreciated that this component may include a general-purpose operating system such as a version of UNIX, or LINUX™, or a specialized operating system such as Microsoft Corporation's Windows operating system, or the Apple Corporation's iOS® operating system. The operating system may include, or interface with a Java virtual machine module that enables control of hardware components and/or operating system operations via Java application programs.

Memory 204 may further include one or more data storage 210, which can be utilized by server device 200 to store, among other things, applications 220 and/or other data. For example, data storage 210 may also be employed to store information that describes various capabilities of server device 200. The information may then be provided to another device based on any of a variety of events, including being sent as part of a header during a communication, sent upon request, or the like. Data storage 210 may also be employed to store social networking information including address books, buddy lists, aliases, user profile information, or the like. Data stores 210 may further include program code, data, algorithms, and the like, for use by a processor, such as processor 202 to execute and perform actions. In one embodiment, at least some of data store 210 might also be stored on another component of server device 200, including, but not limited to, non-transitory media inside processor-readable removable storage device 236, processor-readable stationary storage device 234, or any other computer-readable storage device within server device 200, or even external to server device 200.

Data storage 210 may include, for example, image database 212, report database 214, and assessment metric database 216. In some embodiments, image database 212 may store images that are included in exams, such as medical exams. The medical exams may be radiology exams. In at least one embodiment, images may include radiology images. In some embodiments, report databases 212 may store reports that are included in exams, such as medical exams. In at least one of the various embodiments, an exam includes an image stored in image database 214 and a corresponding report stored in report database 214. In at least one embodiment, a link between the image and corresponding report may be provided. In some embodiments, assessment metric database 216 may store assessment metrics. In at least one embodiment, each assessment metric is associated with an exam, including an image and a report. A link between an assessment metric, and at least an associated image or report may be provided. In at least one of various embodiments, at least one of image database 212, report database 214, and assessment metric database 216 may be stored by at least one of, or any combination of, server device 112 and server device 114 of FIG. 1. Although not shown, data storage 210 may include an exam database, wherein the exam database includes at least image database 212 and report database 214. In some embodiments, an exam database may include assessment metric database 216. Each exam in the exam database may include one or more corresponding assessment metrics. In at least one embodiment, at least one exam may include at least one associated record, such as a medical record. The exam database may store one or more medical records associated with at least one exam. In at least one embodiment, each exam included in the exam database may be a anonymized and blinded exam.

Applications 220 may include computer executable instructions which, when executed by server device 200, transmit, receive, and/or otherwise process messages (e.g., SMS, MMS, Instant Message (IM), email, and/or other messages), audio, video, and enable telecommunication with another user of another client device. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. Applications 220 may include, for example, presentation server application 222, reporting application 224, anonymizer application 226, and blinder application 227.

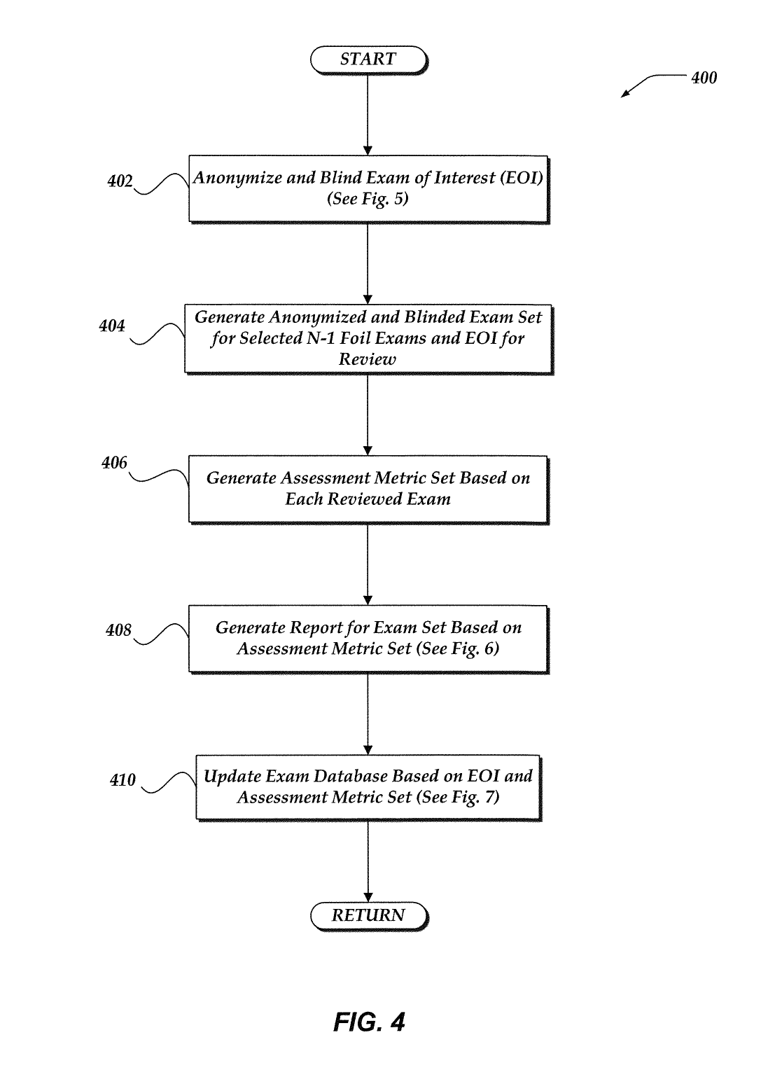

Presentation server application 222 may be configured to enable the presentation, archiving, and communication regarding exams. In at least one embodiment, presentation server application 222 may interact with a client device for enabling a user to present, archive, and communicate regarding an exam. In some embodiments, presentation server application 222 may be configured to generate an exam set. In at least one of the various embodiments, presentation server application 222 may be configured to enable a user to review each exam in the generated exam set. In at least one of the various embodiments, presentation server application 222 may enable a client device to display an exam, including an image and corresponding report. Presentation server application 222 may also enable the client device to display records associated with the exam. In some embodiments, presentation server application 222 may interact with at least one of image database 212, report database 214, and assessment metric database 216. In some embodiments, presentation server application 222 may be employed by server device 112 or 114 of FIG. 1, or any combination of server devices. In any event, presentation server application 222 may employ processes, or parts or processes, similar to those described in conjunction with FIGS. 4-7, to perform at least some actions. In some embodiments, presentation server application 222 may be a Presentation, Archiving, and Communication (PAC) server application. In at least one embodiment, a PAC server application may be a modified PAC server application.

Reporting application 224 may be configured to generate a report for an exam set based on an assessment metric set. In at least one embodiment, reporting application 224 may interact with a client device for enabling selecting at least one assessment metric from an assessment metric set. In some embodiments, reporting application 224 may interact with at least one of image database 212, report database 214, and assessment metric database 216. In some embodiments, reporting application 224 may be employed by server device 112 or 114 of FIG. 1, or any combination of server devices. In any event, presentation reporting application 224 may employ processes, or parts or processes, similar to those described in conjunction with FIGS. 4-7, to perform at least some actions.

Anonymizer application 226 may be configured to anonymize exams, such as medical exams. In at least one embodiment, anonymizer application 226 may be configured to anonymize images included in an exam. Anonymizer application 226 may be configured to anonymize reports corresponding to images included in an exam. Anonymizer application 226 may be configured to anonymize records, such as medical records associated with exams. In some embodiments, anonymizer application 226 may interact with at least one of image database 212, report database 214, and assessment metric database 216. In some embodiments, anonymizer application 226 may be employed by server device 112 or 114 of FIG. 1, or any combination of server devices. In any event, anonymizer application 226 may employ processes, or parts or processes, similar to those described in conjunction with FIGS. 4-7, to perform at least some actions.

Blinder application 227 may be configured to blind exams, such as medical exams. In at least one embodiment, blinder application 227 may be configured to blind images included in an exam. Blinder application 227 may be configured to standardize and blind reports corresponding to images included in an exam. Blinder application 226 may be configured to blind records, such as medical records associated with exams. In some embodiments, blinder application 227 may interact with at least one of image database 212, report database 214, and assessment metric database 216. In some embodiments, blinder application 227 may be employed by server device 112 or 114 of FIG. 1, or any combination of server devices. In any event, anonymizer application 226 may employ processes, or parts or processes, similar to those described in conjunction with FIGS. 4-7, to perform at least some actions.

### Illustrative Client Device

FIG. 3 shows one embodiment of client device 300 that may include many more or less components than those shown. Client device 300 may represent, for example, at least one embodiment of client devices 122-128 shown in FIG. 1.

Client device 300 may include processor 302 in communication with memory 304 via bus 328. Client device 300 may also include power supply 330, network interface 332, audio interface 356, display 350, keypad 352, illuminator 354, video interface 342, input/output interface 338, haptic interface 364, global positioning systems (GPS) receiver 358, open air gesture interface 360, temperature interface 362, camera(s) 340, projector 346, pointing device interface 366, processor-readable stationary storage device 334, and processor-readable removable storage device 336. Client device 300 may optionally communicate with a base station (not shown), or directly with another computing device. And in one embodiment, although not shown, a gyroscope may be employed within client device 300 to measuring and/or maintaining an orientation of client device 300.

Power supply 330 may provide power to client device 300. A rechargeable or non-rechargeable battery may be used to provide power. The power may also be provided by an external power source, such as an AC adapter or a powered docking cradle that supplements and/or recharges the battery.

Network interface 332 includes circuitry for coupling client device 300 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. Network interface 332 is sometimes known as a transceiver, transceiving device, or network interface card (NIC).

Audio interface 356 may be arranged to produce and receive audio signals such as the sound of a human voice. For example, audio interface 356 may be coupled to a speaker and microphone (not shown) to enable telecommunication with others and/or generate an audio acknowledgement for some action. A microphone in audio interface 356 can also be used for input to or control of client device 300, e.g., using voice recognition, detecting touch based on sound, and the like.

Display 350 may be a liquid crystal display (LCD), gas plasma, electronic ink, light emitting diode (LED), Organic LED (OLED) or any other type of light reflective or light transmissive display that can be used with a computing device. Display 350 may also include a touch interface 344 arranged to receive input from an object such as a stylus or a digit from a human hand, and may use resistive, capacitive, surface acoustic wave (SAW), infrared, radar, or other technologies to sense touch and/or gestures.

Projector 346 may be a remote handheld projector or an integrated projector that is capable of projecting an image on a remote wall or any other reflective object such as a remote screen.

Video interface 342 may be arranged to capture video images, such as a still photo, a video segment, an infrared video, or the like. For example, video interface 342 may be coupled to a digital video camera, a web-camera, or the like. Video interface 342 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 352 may comprise any input device arranged to receive input from a user. For example, keypad 352 may include a push button numeric dial, or a keyboard. Keypad 352 may also include command buttons that are associated with selecting and sending images.

Illuminator 354 may provide a status indication and/or provide light. Illuminator 354 may remain active for specific periods of time or in response to events. For example, when illuminator 354 is active, it may backlight the buttons on keypad 352 and stay on while the client device is powered. Also, illuminator 354 may backlight these buttons in various patterns when particular actions are performed, such as dialing another client device. Illuminator 354 may also cause light sources positioned within a transparent or translucent case of the client device to illuminate in response to actions.

Client device 300 may also comprise input/output interface 338 for communicating with external peripheral devices or other computing devices such as other client devices and network devices. The peripheral devices may include an audio headset, display screen glasses, remote speaker system, remote speaker and microphone system, and the like. Input/output interface 338 can utilize one or more technologies, such as Universal Serial Bus (USB), Infrared, WiFi, WiMax, Bluetooth™, and the like.

Haptic interface 364 may be arranged to provide tactile feedback to a user of the client device. For example, the haptic interface 364 may be employed to vibrate client device 300 in a particular way when another user of a computing device is calling. Temperature interface 362 may be used to provide a temperature measurement input and/or a temperature changing output to a user of client device 300. Open air gesture interface 360 may sense physical gestures of a user of client device 300, for example, by using single or stereo video cameras, radar, a gyroscopic sensor inside a device held or worn by the user, or the like. Camera 340 may be used to track physical eye movements of a user of client device 300.

GPS transceiver 358 can determine the physical coordinates of client device 300 on the surface of the Earth, which typically outputs a location as latitude and longitude values. GPS transceiver 358 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of client device 300 on the surface of the Earth. It is understood that under different conditions, GPS transceiver 358 can determine a physical location for client device 300. In at least one embodiment, however, client device 300 may, through other components, provide other information that may be employed to determine a physical location of the device, including for example, a Media Access Control (MAC) address, IP address, and the like.

Human interface components can be peripheral devices that are physically separate from client device 300, allowing for remote input and/or output to client device 300. For example, information routed as described here through human interface components such as display 350 or keyboard 352 can instead be routed through network interface 332 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Zigbee™ and the like. One non-limiting example of a client device with such peripheral human interface components is a wearable computing device, which might include a remote pico projector along with one or more cameras that remotely communicate with a separately located client device to sense a user's gestures toward portions of an image projected by the pico projector onto a reflected surface such as a wall or the user's hand.

A client device may include a browser application 324 that is configured to receive and to send web pages, web-based messages, graphics, text, multimedia, and the like. The client device's browser application 324 may employ virtually any programming language, including a wireless application protocol messages (WAP), and the like. In at least one embodiment, the browser application 324 is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

Memory 304 may include RAM, ROM, and/or other types of memory. Memory 304 illustrates an example of computer-readable storage media (devices) for storage of information such as computer-readable instructions, data structures, program modules or other data. Memory 304 may store BIOS 308 for controlling low-level operation of client device 300. The memory may also store operating system 306 for controlling the operation of client device 300. It will be appreciated that this component may include a general-purpose operating system such as a version of UNIX, or LINUX™, or a specialized mobile computer communication operating system such as Windows Phone™, or the Symbian® operating system. The operating system may include, or interface with a Java virtual machine module that enables control of hardware components and/or operating system operations via Java application programs.

Memory 304 may further include one or more data storage 310, which can be utilized by client device 300 to store, among other things, applications 320 and/or other data. For example, data storage 310 may also be employed to store information that describes various capabilities of client device 300. The information may then be provided to another device based on any of a variety of events, including being sent as part of a header during a communication, sent upon request, or the like. Data storage 310 may also be employed to store social networking information including address books, buddy lists, aliases, user profile information, or the like. Data storage 310 may further include program code, data, algorithms, and the like, for use by a processor, such as processor 302 to execute and perform actions. In one embodiment, at least some of data storage 310 might also be stored on another component of client device 300, including, but not limited to, non-transitory processor-readable removable storage device 336, processor-readable stationary storage device 334, or even external to the client device.

Data storage 310 may include, for example, image storage 312 and report storage 314. In some embodiments, image storage 312 may store images that are included in an exam included in an exam set. Such exams may be medical exams. The medical exams may be radiology exams. In at least one embodiment, images may include radiology images. In some embodiments, report storage 314 may store reports that are included in an exam included in an exam set. In at least one of the various embodiments, an exam set includes a plurality of exams wherein at least one exam is an exam of interest (EOI) and at least one exam is a foil exam. In at least one embodiment, an image stored in image storage 312 corresponds to a report stored in report storage 314. In at least one embodiment, a link between the image and corresponding report may be provided. In at least one embodiment, at least one exam in the exam set may include at least one associated record, such as a medical record. Data storage 310 may store one or more medical records associated with at least one exam in the exam set.

Applications 320 may include computer executable instructions which, when executed by client device 300, transmit, receive, and/or otherwise process instructions and data. Applications 320 may include, for example, presentation client application 322. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

Presentation client application 322 may be configured to enable the presentation, archiving, and communication regarding exams. In at least one embodiment, presentation client application 322 may interact with a server device for enabling a user to present, archive, and communicate regarding an exam. In at least one of the various embodiments, presentation client application 322 may be configured to enable a user to review each exam in an exam set. In at least one of the various embodiments, presentation client application 322 may enable a client device to display an exam, including an image and corresponding report. Presentation client application 322 may also enable the client device to display records associated with the exam. In at least one of the various embodiments, presentation client application 322 may enable the generation of an assessment metric set based on the user reviewing each exam in the exam set. In some embodiments, presentation client application 322 may interact with at least one of image storage 312 and report storage 314. In at least one embodiment, presentation client application 322 may interact with browser application 324. In some embodiments, presentation client application 322 may be employed by at least one of client devices 122-128 of FIG. 1, or any combination of client devices. In any event, presentation client application 322 may employ processes, or parts or processes, similar to those described in conjunction with FIGS. 4-7, to perform at least some actions. In some embodiments, presentation client application 322 may be a Presentation, Archiving, and Communication (PAC) client application. In at least one embodiment, a PAC client application may be a modified PAC client application.

### General Operation

The operation of certain aspects of the invention will now be described with respect to FIGS. 4-9. FIG. 4 illustrates a logical flow diagram generally showing one embodiment of an overview process for generating reviews of exams. In some embodiments, process 400 of FIG. 4 may be implemented by and/or executed on a single server device, such as server device 200 of FIG. 2. In other embodiments, process 400 or portions of process 400 of FIG. 4 may be implemented by and/or executed on a plurality of server devices, such as network device 200 of FIG. 2. In yet other embodiments, process 400 or portions of process 400 of FIG. 4 may be implemented by and/or executed on one or more client devices, such as client device 300 of FIG. 3. In at least one embodiment, process 400 or portions of process 400 of FIG. 4 may be implemented by and/or executed on a combination of one or more server devices, such as server device 200 of FIG. 2 and a combination of one or more client devices, such as client device 200 of FIG. 3. However, embodiments are not so limited and various combinations of server devices, such as server device 112 and 114 of FIG. 1 and client devices, such as client devices 122-128 of FIG. 1, or the like may be utilized.

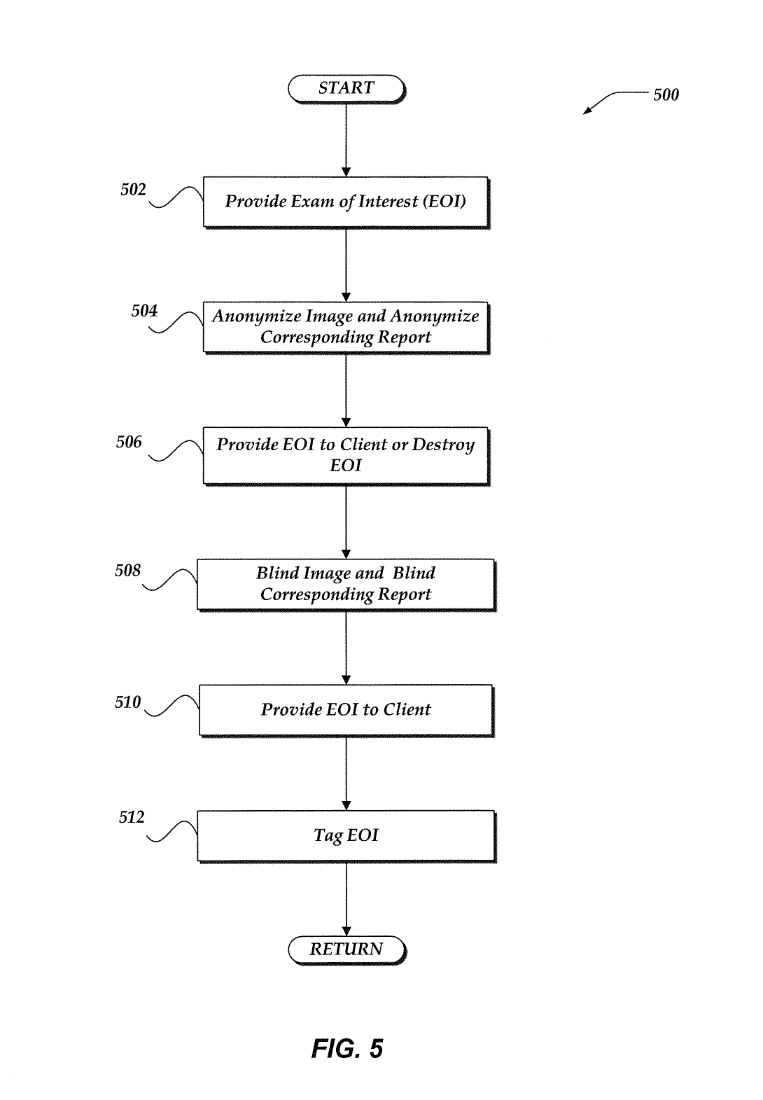

Process 400 begins, after a start block, at block 402, where an exam of interest (EOI) is anonymized. In at least one embodiment, the EOI may be blinded at block 402. Block 402 is described in more detail with regard to FIG. 5. However, briefly stated, at block 402, an EOI may be anonymized and blinded. Furthermore, the EOI may be tagged at block 402. In some embodiments, the anonymized and blinded EOI may be an annotated exam. In at least one embodiment, a subject associated with the anonymized and blinded EOI may not be identifiable. In at least one embodiment, an exam database may be updated to include the anonymized and blinded EOI at block 402.

Process 400 proceeds to block 404, where an anonymized and blinded exam set for selected N−1 foil exams and the EOI is generated for review. In at least one embodiment, the N−1 selected foil exams are selected from an exam database. In at least one embodiment, one or more of the foil exams may be manually and/or automatically selected from the exam database. The exam database may include at least one of an image database, a report database, or an assessment metric database.

In at least one embodiment, N may be an integer great than 1. In at least some of the various embodiments, N may be greater than or equal to 10. In at least one of the various embodiments, the generated exam set includes the EOI and each of the selected foil exams. In at least one of the various embodiments, each selected foil exam includes at least one image stored in an image database. In at least one embodiment, each selected foil exam may include at least one report stored in a report database and which corresponds to the at least one image.

In at least some of the various embodiments, each of the foil exams selected from the exam database are anonymized and blinded. In at least one embodiment, each of the foil exams are anonymized and blinded prior to being included in the exam database. In at least one of the various embodiments, at least a portion of the foil exams selected from the exam database may have been previously tagged, such as in a process depicted in block 512 of FIG. 5. The tagged foil exams may include various identifiers, such as, but not limited to modality identifiers, body part identifiers, sub-specialty identifiers, organ system identifiers, and the like. In at least one embodiment, at least one of the selected foil exams may be an annotated foil exam. In at least some of the various embodiments, at least one of the selected foil exams may correspond with at least one previously generated assessment metric, included in the exam database. In at least one embodiment, each previously determined assessment metric may be generated based on at least another review by at least one other reviewer.

In at least one embodiment, the selection of N−1 foil exams may be based on at least a set of batch requirements. The batch requirements may be provided by a client. In various embodiments, the client may be at least one of an attorney, a law firm, an insurance company, a litigant, a doctor, a medical clinic, an educational institution, a medical board, a patient, and the like. In at least one embodiment, the client may be a subject associated with the EOI. In at least one embodiment, the client may have provided the EOI. In some embodiments, the batch requirements may be client requirements. In at least one embodiment, the batch requirements may be based on one or more properties, qualities, characteristics, aspects, or attributes of the EOI.

In at least one embodiment, batch requirements may include selection criteria for the foil exams. Batch requirements may include, but are not limited to, modality of a foil exam, body part associated with the foil exam, the clinical setting of the foil exam, sub-specialty of the foil exam, a total number of selected foil exams, such as N−1, a total width of a distribution of the selected foil exams, number of previous reviews of a foil exam, and the like. In at least one embodiment, a search is performed over the exam database to select foil exams that closely meet the search criteria included in the batch requirements. In at least one embodiment, a best-fit method based on the batch requirements and the exam database is employed to select the N−1 foil exams from the exam database. In some embodiments, the best-fit method is based on at least various identifiers included with annotated exams in the exam database. In at least one embodiment, the employed best-fit method may insure that an exam previously reviewed by the reviewer is not selected as a foil exam.

In some embodiments, the generated anonymized and blinded exam set includes the EOI and the selected N−1 foil exams. In at least one embodiment, each exam included in the exam set is a blinded and anonymized exam. In at least one embodiment, a mapping data structure is generated that maps an indication that identifies if an exam is an EOI or if the exam is a foil exam, to each exam included in the exam set.

In some embodiments, the exam set may include at least one anonymized and blinded record, where the at least one record is associated with at least one exam in the exam set. In at least one embodiment, each record included in the exam set may have been provided to the examiner, at the time of examination of the associated exam. In some embodiments, the anonymized and blinded exam set does not include information that would allow a reviewer to determine which exam in the exam set is an EOI and which exams in the exam set are foil exams. In at least one embodiment, the generated mapping data structure is not provided to the reviewer.

At any rate, process 400 may proceed to block 406, where an assessment metric set based on each reviewed exam may be generated. In at least one embodiment, the anonymized and blinded exam set generated at block 404 may be provided to a client device, such as client device 300 of FIG. 3. In some embodiments, the blinded and anonymized exam set may be provided to or otherwise displayed for a reviewer to review each exam in the exam set. In at least one embodiment, the reviewer may be a user of the client device that was provided the anonymized and blinded exam set.

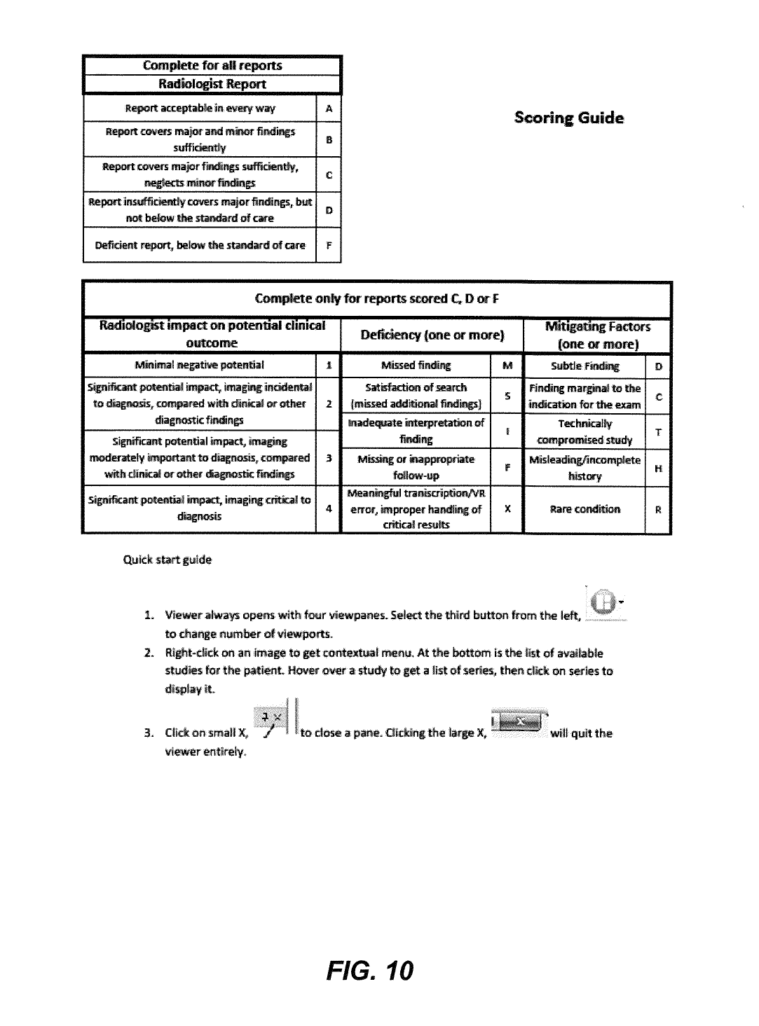

In at least one embodiment, the reviewer reviews each exam in the exam set, including the EOI and each foil exam, without the ability to discriminate between an EOI and a foil exam. In at least one embodiment, during the review for each exam, the reviewer is provided with a simulated data environment similar to the data environment available to the examiner at the time of examination. The simulated data environment may be provided in the form of anonymized records, images, reports, histories, and the like either, included in the exams in the exam set, or associated with the exams in the exam set. In some embodiments, the reviewer may be provided with a predetermined limited amount of time in which to review each exam set in the exam set. FIG. 10 illustrates an exemplary form that enables the reviewer to review at least one exam in a relatively standardized manner, such as discussed herein. Although not shown, in at least one of the various embodiments, a form may be similarly provided that indicates a binary grade for the review, for example, pass or fail to meet a duty of care.

In at least one embodiment, a data environment may be an adaptive data environment. In some embodiments, an adaptive data environment may adapt to provide the exams in a similar manner as to how the exams and associated records may have been presented to the examiner and previous reviewers. In at least one embodiment, the adaptive data environment may adapt to simulate various options, features, display technologies, and the like that were provided to the examiner and previous reviewers. In at least one embodiment, the data environment provided to the reviewer simulates another data environment that was previously provided for initially generating each exam.

In some embodiments, an assessment metric may be generated for each reviewed exam. In at least one embodiment, each generated assessment metric may be based on the reviewer's review of the corresponding exam. In at least one embodiment, the generated assessment metric may be based on a ex post facto determination by the reviewer. In at least one of the various embodiments, the ex post facto determination may be in regards to an aspect of the reviewed exam, such as a diagnosis or other determination included in the reviewed exam.

In at least one embodiment, the generated assessment metric set includes each generated assessment metric for each reviewed exam. In at least one embodiment, each assessment metric included on the assessment metric set corresponds to an exam in the exam set. In some embodiments, the generated assessment metric set may include the generated assessment metric set based on the reviewer's review of the EOI, and N−1 generated assessment metrics, each based on the reviewer's review of each of the corresponding N−1 foil exams.

In some embodiments, a reviewer may generate at least one assessment metric of the assessment metric set at a client device. In at least one embodiment, the generated assessment metric set may be provided to a server device, such as server device 200 of FIG. 2. In other embodiments, each generated assessment metric may be provided to a server device, and the assessment metric set may be generated at the server device and based on at least each provided assessment metric.

In at least one embodiment, the generated assessment metric may be based on an ex post facto determination by the reviewer. In some embodiments, the ex post facto determination may be in regards to whether an ex-ante determination included in the reviewed exam either met a standard, or alternatively, fell below a standard. In at least one embodiment, the standard may be a standard of care. In at least one of the various embodiments, the ex-ante determination included in the reviewed exam may include at least one of a diagnosis, a finding, or an impression.

In at least one embodiment, the generated assessment metric may include an overall quality element. In at least one of the various embodiments, the overall quality element may take on graded values, e.g., A, B, C, D, or F. In some embodiments, an overall quality element value of A may indicate that the reviewer determined, based on the review of the exam, that the reviewed exam includes a report that is acceptable in every way. In some embodiments, an overall quality element value of B may indicate that the reviewer determined, based on the review of the exam, that the reviewed exam includes a report that covers major and minor findings sufficiently. In some embodiments, an overall quality element value of C may indicate that the reviewer determined, based on the review of the exam, that the reviewed exam includes a report that covers major findings sufficiently, but neglects minor findings. In some embodiments, an overall quality element value of D may indicate that the reviewer determined, based on the review of the exam, that the reviewed exam includes a report that insufficiently covers major findings, but that the report is not below the standard of care. In some embodiments, an overall quality element value of F may indicate that the reviewer determined, based on a review of the exam, that the reviewed exam includes a report that is deficient enough to be below the standard of care. In at least one of the various embodiments, the overall quality element may be a binary element. A binary overall quality element may indicate that the reviewer determined, based on the review of the exam, that the reviewed exam includes a report that is either above or below the standard of care.

In at least one embodiment, the generated assessment metric may include an impact on outcome element. In at least one of the various embodiments, the impact on outcome element may take on graded values of 1, 2, 3, or 4. In some embodiments, an impact on outcome element value of 1 may indicate that the reviewer determined, based on the review of the exam that any errors, omissions, or deficiencies included in the report or image would have minimal negative potential impact on the clinical outcome. In some embodiments, an impact on outcome element value of 2 may indicate that the reviewer determined based on the review of the exam that any errors, omissions, or deficiencies included in the report or image would have significant potential impact, and imaging incidental to diagnosis, compared with clinical or other diagnostic findings. In some embodiments, an impact on outcome element value of 3 may indicate that the reviewer determined based on the review of the exam that any errors, omissions, or deficiencies included in the report or image would have significant potential impact, and imaging moderately important to diagnosis, compared with clinical or other diagnostic findings. In some embodiments, an impact on outcome element value of 4 may indicate that the reviewer determined based on the review of the exam that any errors, omissions, or deficiencies included in the report or image would have significant potential impact, and imaging critical to diagnosis.

In at least one embodiment, the generated assessment metric may include one or more deficiency elements. In at least one of the various embodiments, the one or more deficiency elements may take on values of M, S, I, F, or X. In some embodiments, a deficiency element value of M may indicate that the reviewer determined based on the review of the exam that the exam missed at least one finding. In some embodiments, a deficiency element value of S may indicate that the reviewer determined based on the review of the exam that the exam missed additional findings. In some embodiments, a deficiency element value of I may indicate that the reviewer determined based on the review of the exam that the exam included at least one inadequate interpretation of a finding. In some embodiments, a deficiency element value of F may indicate that the reviewer determined based on the review of the exam that the examiner failed to follow-up or conducted an inappropriate follow up. In some embodiments, a deficiency element value of X may indicate that the reviewer determined based on the review of the exam that the exam included at least one transcription error or that critical results were improperly handled.

In at least one embodiment, the generated assessment metric may include one or more mitigating factor elements. In at least one of the various embodiments, the one or more mitigating factor elements may take on values of D, C, T, H, or R. In some embodiments, a mitigating factor element value of D may indicate that the reviewer determined based on the review of the exam that the exam included at least one subtle finding. In some embodiments, a mitigating factor element value of C may indicate that the reviewer determined based on the review of the exam that the exam included at least one finding marginal to the indication of the exam. In some embodiments, a mitigating factor element value of T may indicate that the reviewer determined based on the review of the exam that the exam technically compromised a study. In some embodiments, a mitigating factor element value of H may indicate that the reviewer determined based on the review of the exam that the exam included a misleading history or the exam lacked a complete history. In some embodiments, a mitigating factor element value of R may indicate that the reviewer determined based on the review of the exam that the exam is associated with a rare condition.

In at least one embodiment, each generated assessment metric may include other assessment metric elements not discussed herein. In at least one embodiment, at least one generated assessment metric may not include all assessment metric elements. In some embodiments, the value of an assessment metric element may be based on a value of at least one other assessment metric element. For instance, in some embodiments, a value of an impact on outcome element may be based on at least the corresponding overall quality element.

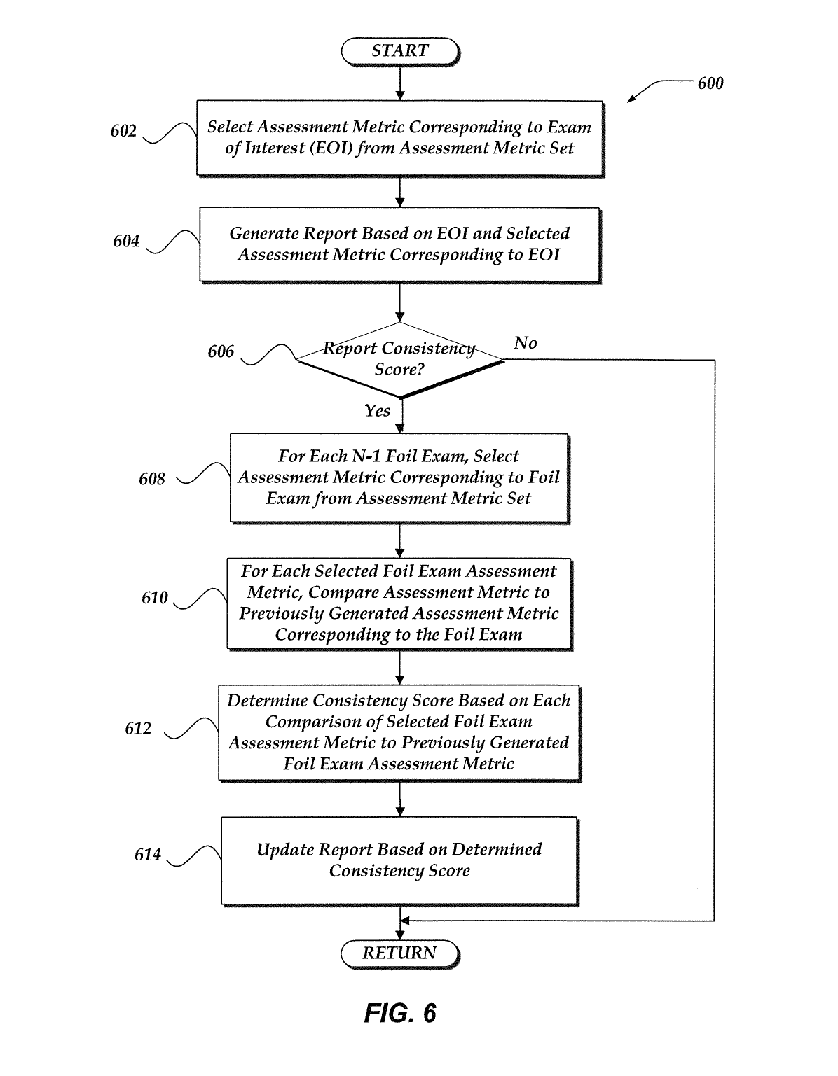

At any rate, process 400 proceeds to block 408, where a report may be generated for the exam set. Block 408 is described in more detail with regard to FIG. 6. However, briefly stated, at block 408, a report may be generated for the exam set, where the generated report is based at least on the assessment metric set generated at block 406. In at least one embodiment, the report may be generated at a server device, such as server device 200 of FIG. 200. In at least one embodiment, the generated report may indicate the assessment metric corresponding to the EOI. In at least one embodiment, the generated report may indicate a consistency score for the reviewer. In at least one embodiment, the consistency score may be based at least on a comparison of other reports generated by other reviewers for the same exams reviewed by the reviewer.

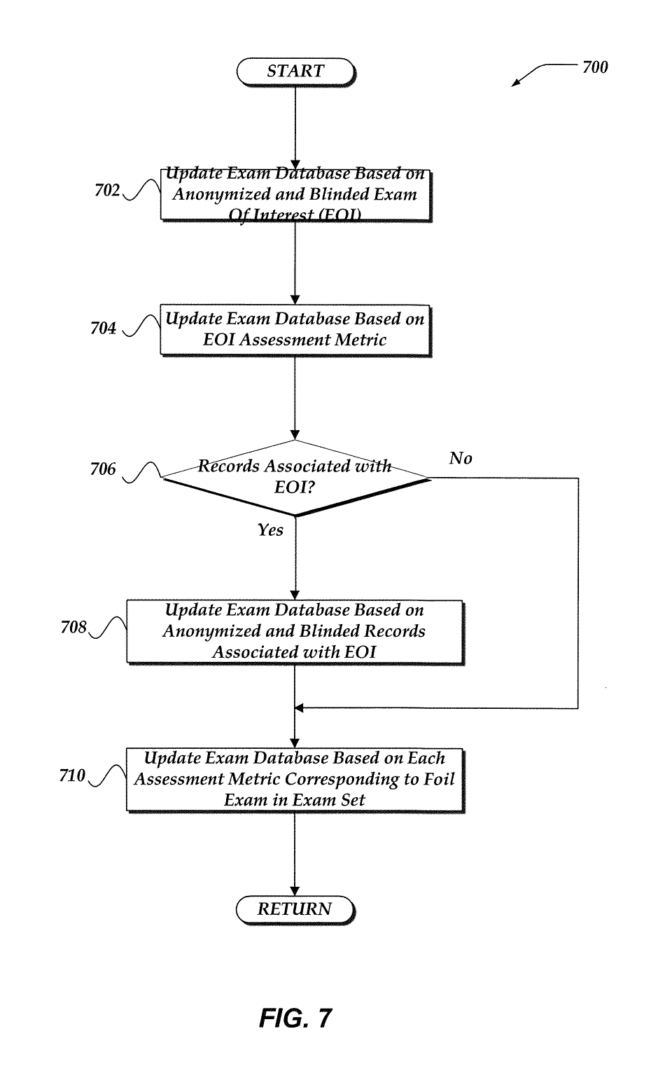

Process 400 proceeds to block 410, where the exam database may be updated. Block 410 is described in more detail with regard to FIG. 7. However, briefly stated, at block 410, the exam database may be updated based on the EOI and the assessment metric set. In at least one embodiment, the exam database may be updated at a server device. In some embodiments, the exam database may be updated to include the anonymized EOI. In at least one embodiment, the exam database may be updated to include at least one assessment metric included in the assessment metric set generated at block 406. In some embodiments, the exam database may be updated to include a consistency score based on at least the reviewer's review of the exam set and the generated assessment metric set.

After block 410, process 400 may return to a calling process to perform other actions.

FIG. 5 illustrates a logical flow diagram generally showing one embodiment of a process for anonymizing and blinding an EOI. In some embodiments, process 500 of FIG. 5 may be implemented by and/or executed on a single server device, such as server device 200 of FIG. 2. In other embodiments, process 500 or portions of process 500 of FIG. 5 may be implemented by and/or executed on a plurality of server devices, such as network device 200 of FIG. 2. In yet other embodiments, process 500 or portions of process 500 of FIG. 5 may be implemented by and/or executed on one or more client devices, such as client device 300 of FIG. 3. In at least one embodiment, process 500 or portions of process 500 of FIG. 5 may be implemented by and/or executed on a combination of one or more server devices, such as server device 200 of FIG. 2 and a combination of one or more client devices, such as client device 200 of FIG. 3. However, embodiments are not so limited and various combinations of server devices, such as server device 112 and 114 of FIG. 1 and client devices, such as client devices 122-128 of FIG. 1, or the like may be utilized.

Process 500 begins, after a start block, at block 502, where an EOI is provided. In at least one embodiment, the EOI interest may be provided to at least a server device, such as server device 200 of FIG. 2. In at least one embodiment, the EOI may be provided by the client. In various embodiments, the client may be at least one of an attorney, a law firm, an insurance company, a litigant, a doctor, a medical clinic, educational institution, a medical board, a patient, and the like. In at least one embodiment, the client may be a subject associated with the EOI.

Process 500 proceeds to block 504, where an image included in the EOI is anonymized. In at least one embodiment, all images included in the EOI are anonymized. In some embodiments, at least one report associated with the EOI and the anonymized image is anonymized. In at least one embodiment, all reports associated with the EOI are anonymized. In at least one embodiment, at least one report is standardized at block 504. In some embodiments, all records, and other datasets, associated with the EOI are anonymized. In at least one embodiment, the EOI is anonymized at block 504. In some embodiments, an anonymizer application, such as anonymizer application 226 of FIG. 2 may anonymize at least one image, report, or record at block 504.

At any rate, process 500 proceeds to block 506, where the client may be provided with the EOI. In at least one embodiment, the non-anonymized EOI may be provided to the client. In at least one embodiment, a server device, such as server device 200 of FIG. 2 provides the EOI to the client. In at least one embodiment, rather than providing the non-anonymized EOI to the client, the non-anonymized EOI is destroyed.

Process 500 proceeds to block 508, where an image included in the EOI is blinded. In at least one embodiment, all images included in the EOI are blinded. In at least one of the various embodiments, at least one report corresponding to the blinded image, and associated with the EOI, may be blinded. In at least one embodiment, all reports associated with the EOI may be blinded. In at least one embodiment, at least one report may be standardized at block 504. In some embodiments, all records, and other datasets, associated with the EOI may be blinded. In at least one embodiment, the EOI may be blinded at block 504. In some embodiments, a blinder application, such as blinder application 227 of FIG. 2 may blind at least one image, report, or record at block 508. In at least one embodiment, the blinding step may redact, change, or replace any information that could identify the patient or an institution, such as a medical center.

At any rate, process 500 proceeds to block 510, where the client may be provided with the EOI. In at least one embodiment, the anonymized and blinded EOI may be provided to the client. In at least one embodiment, a server device, such as server device 200 of FIG. 2 may provide the anonymized and blinded EOI to the client. In at least one embodiment, the anonymized and blinded EOI may be included in the exam database at block 510.

Process 500 proceeds to block 512, where the EOI may be tagged. In at least one embodiment, the EOI may be updated to include various identifiers. In at least one embodiment, the identifiers may be based on at least one or more property, quality, characteristic, aspect, or attribute of the EOI. In some embodiments, the EOI may be tagged to include at least a modality identifier. In at least one embodiment, a modality identifier may identify a modality of at least one image included in the EOI. Examples of modality identifiers include, but at not limited to x-ray, ultrasound, MRI, PET, CT, CAT, and the like.

In some embodiments, the EOI may be tagged to include at least a body part identifier. In at least one embodiment, a body part identifier may identify a body part associated with the EOI or at least one image included in the EOI. Examples of body part identifiers may include, but are not limited to head, neck, chest, knee, shoulder, wrist, and the like.

In some embodiments, the EOI may be tagged to include at least a sub-specialty identifier. In at least one embodiment, a sub-specialty identifier may identify a sub-specialty associated with the EOI. Examples of sub-specialty identifiers may include, but are not limited to neuro-exam, muscoskeletal exam, and the like.

In some embodiments, the EOI may be tagged to include at least a disease process identifier. In at least one embodiment, a disease process identifier may identify a disease process associated with the EOI. Examples of disease process identifiers may include, but are not limited to trauma, cancer, heart disease, and the like.

In some embodiments, the EOI may be tagged to include at least an organ system identifier. In at least one embodiment, an organ system identifier may identify an organ system associated with the EOI. Examples of organ system identifiers may include, but are not limited to gastrointestinal (GI) system, neurological system, skeletal system, reproductive system, auditory system, vision system, and the like.

In at least one embodiment, the EOI may be tagged to include an identifier that identifies the EOI as the EOI. In such embodiments, the EOI identifier may not be provided to, or otherwise accessible by a reviewer. In at least one embodiment, an exam tagged with identifiers, such as in a process described in relation to block 512 may also be annotated with additional information, related to the exam. In some embodiments, the exam database may be updated to include the anonymized and blinded EOI, which may be tagged and/or annotated.

At any rate, after block 512, process 500 may return to a calling process to perform other actions.

FIG. 6 illustrates a logical flow diagram generally showing one embodiment of a process for generating a report for an exam set based on an assessment metric set. In some embodiments, process 600 of FIG. 6 may be implemented by and/or executed on a single server device, such as server device 200 of FIG. 2. In other embodiments, process 600 or portions of process 600 of FIG. 6 may be implemented by and/or executed on a plurality of server devices, such as network device 200 of FIG. 2. In yet other embodiments, process 600 or portions of process 600 of FIG. 6 may be implemented by and/or executed on one or more client devices, such as client device 300 of FIG. 3. In at least one embodiment, process 600 or portions of process 600 of FIG. 6 may be implemented by and/or executed on a combination of one or more server devices, such as server device 200 of FIG. 2 and a combination of one or more client devices, such as client device 200 of FIG. 3. However, embodiments are not so limited and various combinations of server devices, such as server device 112 and 114 of FIG. 1 and client devices, such as client devices 122-128 of FIG. 1, or the like may be utilized.

Process 600 begins, after a start block, at block 602, where the assessment metric corresponding to the EOI from the assessment metric set is selected. In some embodiments, the assessment metric set is provided to a server device, such as server device 200 of FIG. 2. In at least one embodiment, the assessment metric corresponding to the EOI is selected at the server device.

It at least one embodiment, the assessment metric corresponding to the EOI may selected based on at least a random medical record number (MRN) corresponding to the EOI. A random MRN may be provided to the EOI in a blinding process, such as the process depicted in block 508 of FIG. 5. In at least one embodiment, the assessment metric corresponding to the EOI may be selected based at least on an identifier included in a tagging process, such as the process depicted in block 512 of FIG. 5. In at least one embodiment, the assessment metric corresponding to the EOI may be selected based at least on other annotations associated with the EOI. In some embodiments, the assessment metric corresponding to the EOI may be selected based on at least a mapping data structure, such as the mapping data structure discussed in regards to block 404. At any rate, the assessment metric corresponding to the EOI may be selected based on information not provided to the reviewer.

Process 600 proceeds to block 604, where a report is generated based on the EOI and the assessment metric corresponding to the EOI, selected in block 602. In at least one of the various embodiments, the report may be generated by a reporting application, such as reporting application 224 of FIG. 2. In at least one embodiment, the report includes at least the assessment metric corresponding to the EOI. In some embodiments, the report includes at least one assessment metric element included in the assessment metric corresponding to the EOI. In at least one embodiment, the generated report includes at least the overall quality element. In some embodiments, the report may include at least one other assessment metric element, such as an impact of outcome element, one or more deficiency elements, and one or more mitigating factor elements. In some embodiments, the generated report may include each of the assessment metrics included in the assessment metric set, with an indication for which assessment metric corresponds to the EOI and which assessment metric correspond to the N−1 foil exams. In at least one embodiment, the generated report may be provided to the client.

Process 600 next proceeds to decision block 606, where a determination may be made whether to report a consistency score. In some embodiments, the determination may be based on the client that provided the EOI. In at least one embodiment, the determination may be based on at least a fee paid by the client. If a consistency score is to be reported, process 600 proceeds to block 608; otherwise process 600 may return to a calling process to perform other actions. In some embodiments, process 600 may continue to block 608 even if a consistency score is not to be reported to the client.

At block 608, for each of the N−1 foil exams in the exam set, the assessment metric corresponding to the foil exam from the assessment metric set may be selected. The selection of each assessment metric set corresponding to a foil exam may be based on similar considerations as those discussed with regard to block 602, including at least, but not limited to a mapping data structure and a random MRN. In at least one embodiment, block 608 may be performed even if a consistency score is not to be reported.

At block 610, for each foil exam assessment metric selected at block 608, the selected assessment metric corresponding to the foil exam may be compared to at least one previously generated assessment metric corresponding to the same foil exam. In at least one embodiment, the previously generated assessment metric may be based on a previous review of the foil exam by at least one other reviewer. In at least one embodiment, the at least one previously generated assessment metric may be stored in an assessment metric database, such as assessment metric database 216 of FIG. 2.

In at least one of the various embodiments, the comparison may be made on an element by element basis, such as when an element in the selected assessment metric is compared to a corresponding element in a previously generated assessment metric for the same foil exam. For instance, an overall quality metric in the selected assessment metric may be compared with the overall quality metric in the previous assessment metric. In some embodiments, a distance may be calculated between the elements in an element by element comparison. In at least one embodiment, the previously generated assessment metric may include fewer or more elements than the assessment metric corresponding to the foil exam selected from the assessment metric set. In at least one embodiment, block 610 may be performed even if a consistency score is not to be reported.

At any rate process 600 proceeds to block 612, where a consistency score based on each comparison of the selected foil exam assessment metric to the previously generated foil exam assessment metric may be determined. In at least one embodiment, each previously generated foil assessment metric corresponding to the foil exam may correspond to a previous review of the foil exam. In at least one embodiment, the determination of the consistency score may be based on the reviewer's review of the exam set. The reviewer's review of the exam set may include a current review. In some embodiments, the current review may be based on an assessment metric set, generated in a process, such as the process depicted in block 406 of FIG. 4. In at least one embodiment, the consistency score may be based on at least one reference review for each of the foil exams included in the exam set. In some embodiments, each reference review may be based on at least one assessment metric set, generated based on at least one previous review of the foil exam, by at least one other reviewer. In at least one embodiment, a reference rating may be determined for each foil exam, where each reference rating may be based on the one or more reference reviews. In some embodiments, the consistency score may be based on at least each reference rating for the foil exams included in the exam set.

In at least one embodiment, the consistency score measures the reviewer's consistency in rating the foil exams included in the exam set. In some embodiments, the consistency score indicates a level of confidence or reliability in the reviewer's review of the EOI. In at least one embodiment, the consistency score explicitly accounts for qualitative differences in the values of the overall quality assessment metric element. For instance, the consistency score may account for qualitative differences in overall quality values between A-B, C-D, and F. In some embodiments, the consistency score may be based on the number of foil exams, N−1, in the reviewed exam set. In at least one embodiment, the consistency score may be based on at least a total number of exams in the exam database.

In some embodiments, the consistency score may be based on a difficulty rating of each foil exam in the exam set. For instance, in at least one embodiment, the difficulty rating of a particular foil exam may be proportional to a variability in assessment metrics previously generated for the foil exam and based on a comparison to a plurality previous reviews conducted by a plurality of different reviewers. In at least one embodiment, the consistency score may be less sensitive to variations where there has been less agreement among the reference reviews corresponding to the foil cases included in the exam set.

In some embodiments, a reliability of the consistency score increases with the number of foil exams included in the data set. In at least one embodiment, the consistency score may include error bars, where a size of the error bars may be based on at least the number of foil exams included in the exam set. In at least one embodiment, the consistency score may be based on a percentage scale, where a score of 100% may indicate an exact match between the current review and the reference reviews for each of the foil exams included in the exam set. In some embodiments, the percentage score may account for a degree of mismatch between the current review and the reference reviews. For instance, the consistency score may account for the difference between an overall quality assessment metric element value of A and B, as compared to a difference between A and D, where the first value may correspond to the current review and the second value may correspond to thee reference reviews. Furthermore, the consistency score may account for at least one of a direction or a consistency in the difference between a current review and reference reviews, such as the case when the reviewer is consistently too lenient, consistently too harsh, or inconsistent in the direction of mismatch between their current review of the foil exams and the reference reviews of the foil exam.

In at least one embodiment, a reference rating for each foil exam may be determined. The reference rating for each foil exam may be based on ratings for the reference reviews, where the reference review ratings are based on at least the previously generated assessment metrics for the foil exam. A distance between the current review of the foil exam and the reference reviews of the foil exam may be determined, where the current review is based on the assessment metric corresponding to the foil exam and selected at block 608. In at least one embodiment, the distance may be normalized based on an overall degree of consensus among the reference reviews. In some embodiments, a total preliminary score may be determined based on the sum of the normalized distance for each foil exam in the exam set. A consistency score, ranging from 0%400% may be determined based on the total preliminary score and an empirical distribution based on a large number of reference reviews included in the exam database.

In at least some embodiments, the consistency score may indicate a percentile from a distribution of neutral reviewers. For instance, a consistency score of 50% may indicate that half of neutral reviewers, given the same exam set, would receive a lower score. Likewise, a consistency score of 10% may indicate that 10% of reviewers would receive a lower score.

In come embodiments, the assessment metric corresponding to a foil exam includes at least four ratings or assessment metric elements: overall quality, impact on outcome, deficiency and mitigating factor elements. For each rating of each reviewed foil exam, a sub-score may be determined. A total score for each foil exam may be determined based on a weighted sum of the sub-scores. In some embodiments, weights may be assigned to each type of rating to reflect an overall importance in determining a review quality.

In at least one embodiment, for each foil case, a consensus rating may be determined. The consensus rating may be based on the reference reviews of the foil exam. The consensus rating may be based on at least one of a mean associated with the reference reviews, a central reviewer included in the reference reviews (based on external information which renders this particular single review very reliable), or an explicit consensus among several reference reviewers. At least one assessment metric included in the assessment metric set for the current review may be compared to the consensus rating for each the foil exams in the exam set.

In at least one embodiment, the distance between the current review and the reference reviews may be based on the determined consensus rating. In some embodiments, the distance may include a distance between the current review and the consensus rating. This distance may indicate the degree of agreement or disagreement with the consensus rating. This distance may be determined in any reasonable quantitative fashion. For instance, a non-limiting example of determining a distance for the overall quality assessment metric element for the current review and the consensus review is indicated in Table 1.

TABLE 1
Exemplary determination of distances between the
overall quality assessment metric elements for
the current review and the consensus review

| Current | Consensus | |
|---|---|---|
| Review | Rating | Distance |
| A | A | 0 |
| A | B | 1 |
| A | C | 1 + 2 = 3 |
| A | D | 1 + 2 + 1 = 4 |
| A | F | 1 + 2 + 1 + 3 = 7 |
| B | B | 0 |
| B | C | 1 |
| B | D | 1 + 2 = 3 |
| B | F | 1 + 2 + 3 = 6 |
| C | C | 0 |
| C | D | 1 |
| C | F | 1 + 3 = 4 |
| D | D | 0 |
| D | F | 3 |
| F | F | 0 |

In some embodiments, the determined distance may be normalized by a variance of the reference ratings. A large variance in the reference rating may indicate a foil exam difficult to score. Thus, and absolute difference may be interpreted as a smaller normalized difference in regards to a foil exam difficult to score. By contrast, if the variance among reference reviewers is small, a relatively small absolute difference may be penalized.

In some embodiments, determination of the variance of reference ratings may be based on a weighted combination of the reference reviewers and a typical variance associated with similar foil exams included in the exam database. Accordingly, the determined variance may be stabilized when the number of reference reviewers is small. In at least one embodiment, as the number of reference reviews increases for a given foil exam, the weight associated with the foil exam is increased. In at least one embodiment, only foil exams with a weight greater than a pre-determined threshold may be utilized. In some embodiments, only foil exams with a number of reference reviews greater than another predetermined threshold are utilized. In at least one embodiment, at least one of the predetermined threshold or the other predetermined threshold may be based on at least batch requirements.

In some embodiments, a final score for the current review may be mapped from the weighted sum of a sub-score and based on a determined normalized distance based on each foil exam in the data set. In at least one embodiment, the mapping may be based on the exam database. For instance, the sum of the distance based scores from each foil exam may be summed to determine a total preliminary score. In at least one embodiment, a reference distribution of preliminary scores may be generated, based on a large number of reference reviews selected from the exam database. The reference distribution may be calibrated in some embodiments. A scaled value, ranging from 0%-100%, may be generated based on the distribution, where the value corresponds to a probability that a set of ratings may have a preliminary score greater than or equal to the observed value, if the set of ratings were determined in a similar manner as the reference reviews. The consistency score may be based on the final score.

In at least one embodiment, the consistency score may be analogous to a p-value. For example, if each foil exam reviewed matched a reference review, the distance between the current review and the reference review would be 0 and the total preliminary score would be 0. The final score would be 100%. In some embodiments, the consistency score may be set equal to the final score. In some embodiments, the final score may decrease with increasing distance between the current review and reference reviews. In at least one embodiment, reviewers may be presumed neutral unless the distance of their reviews is currently greater than a predetermined distance threshold. In at least one embodiment, the predetermined distance threshold may be based on at least batch requirements. In at least one embodiment, block 610 may be performed even if a consistency score is not to be reported.

Additionally, in at least of the various embodiments, statistical information and heuristic information may be determined for at least one the exam set, foil exams, EOIs, reviewers, and examiners.

Process 600 proceeds to block 614, where the report generated at block 604 may be updated based on the consistency score determined at block 612. In at least one embodiment, the report is updated to include the consistency score. In at least one embodiment, the report may be updated to include the assessment metric corresponding to each foil exam in the exam set. In at least one embodiment, the report is updated to include at least a portion of each foil exam in the exam set. In at least one embodiment, the report may be updated to include at least a portion of the reference reviews. In at least one embodiment, the generated report may be provided to the client.

After block 614, process 600 may return to a calling process to perform other actions.

FIG. 7 illustrates a logical flow diagram generally showing one embodiment of a process for updating an exam database based on an EOI and an assessment metric set. In some embodiments, process 700 of FIG. 7 may be implemented by and/or executed on a single server device, such as server device 200 of FIG. 2. In other embodiments, process 700 or portions of process 700 of FIG. 7 may be implemented by and/or executed on a plurality of server devices, such as network device 200 of FIG. 2. In yet other embodiments, process 700 or portions of process 700 of FIG. 7 may be implemented by and/or executed on one or more client devices, such as client device 300 of FIG. 3. In at least one embodiment, process 700 or portions of process 700 of FIG. 7 may be implemented by and/or executed on a combination of one or more server devices, such as server device 200 of FIG. 2 and a combination of one or more client devices, such as client device 200 of FIG. 3. However, embodiments are not so limited and various combinations of server devices, such as server device 112 and 114 of FIG. 1 and client devices, such as client devices 122-128 of FIG. 1, or the like may be utilized.

Process 700 begins, after a start block, at block 702, where the exam database may be updated based on at least the anonymized and blinded EOI. In at least one embodiment, the exam database may be updated to include the anonymized and blinded EOI. In at least one embodiment, the anonymized and blinded EOI may be imported into the exam database. In at least one embodiment, the included EOI may be an annotated EOI.

Process 700 proceeds to block 704, where the exam database may be updated based on at least an assessment metric corresponding to the EOI. In at least one embodiment, the exam database may be updated to include the assessment metric corresponding to the EOI. In at least one embodiment, the assessment metric may be imported into the exam database. In some embodiments, the EOI may be deployed as a foil exam in subsequent exam set reviews. In some embodiments, the assessment metric corresponding to the EOI and included in the database may be employed as a previous review for the EOI when the EOI is deployed as a foil exam. In at least one of the various embodiments, the exam database may be updated based on a consistency score, such as a consistency score determined in block 612 of FIG. 6. In at least one embodiment, the exam database may be updated to include the consistency score.

Process 700 proceeds to decision block 706, where a determination may be made whether at least one record associated with the EOI is available. If at least one record associated with the EOI is not available, then process 700 may proceed to block 710. Otherwise if at least one record associated with the EOI is available, then process 700 may proceed to block 708.

At block 708, the exam database may be updated based on at least one anonymized and blinded record associated with the EOI. In at least one embodiment, the exam database may be updated only if the at least one record associated with the EOI was provided at the time of examination. In at least one embodiment, the exam database may be updated to include the at least one anonymized and blinded record. In at least one embodiment, the at least one anonymized and blinded record may be imported into the exam database. In some embodiments, the at least one included record may be a medical record. In at least one embodiment, the at least one record may include at least a portion of a medical history.

In at least one of the various embodiments, the included record may include at least one other exam associated with the same subject as the EOI, such as a patient. As with the EOI, the at least one other associated exam may be included in the exam database. The at least on other included exams may be anonymized and blinded exams. The at least one other exam may be a previous exam that occurred prior to the EOI. The included at least one other exam may be associated with the EOI, such as if it is a previous exam associated with the same body part, disease process, same injury, or such. In at least one embodiment, the included at least one other exam may be unrelated to the EOI. In at least one of the various embodiments, the included at least one other exam may be a prior study.

For instance, a patient may have had a broken arm at one time. An X-ray examination may be included in the patient's medical history. At a time after the arm X-ray, the patient may undergo a heart disease exam. The arm X-ray exam included in the patient's medical history may be provided to the physician examining the patient for heart disease. In this example, the heart disease exam may be an EOI and the arm exam including the arm X-ray may be an associated record. In at least one of the various embodiments, both the EOI and any associated exams may be included in the database. In at least one embodiment, because the exams are anonymized and blinded, the included at least one other exam may be used as a foil exam in subsequent exam reviews. In at least one of the various embodiments, a single reviewed exam set, including an EOI with associated exams may result in the exam database to be updated to include a plurality of exams to be used as foil exams in subsequent exam reviews. Over time, the plurality of included exams may be reviewed by other reviewers and provided with a plurality of assessment metrics, contributing to the overall size and diversity of the exam database.

At block 710, the exam database may be updated based on at least each generated assessment metric corresponding to the foil exams in the exam set. In at least one embodiment, the exam database may be updated to include each assessment metric corresponding to a foil exam in the exam set. In at least one embodiment, each assessment metric corresponding to a foil exam in the exam set may be imported into the exam database. In at least one of the various embodiments, the exam database may be updated to include each assessment metric in the assessment metric set that corresponds to a foil exam. In at least one embodiment, the assessment metrics included in the exam database may be employed as previous reviews of the corresponding foil exams.

After block 710, process 700 may return to a calling process to perform other actions.

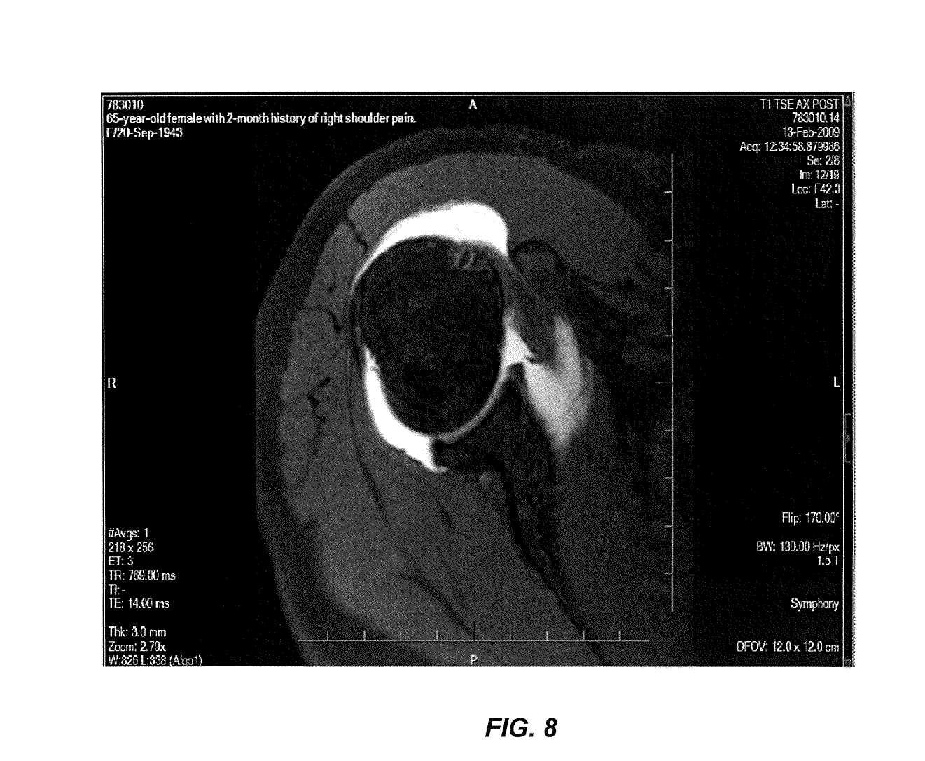

FIG. 8 illustrates a non-exhaustive example of an image included in an exam to be reviewed. The image illustrated in FIG. 8 is a magnetic resonance image (MRI) of a shoulder of a 65 year old female with a 2 month history of right shoulder pain. The image is an anonymized and blinded image. The subject of the image is anonymous and a reviewer is unable to determine if this image is included in an EOI or if the image is included in a foil exam.

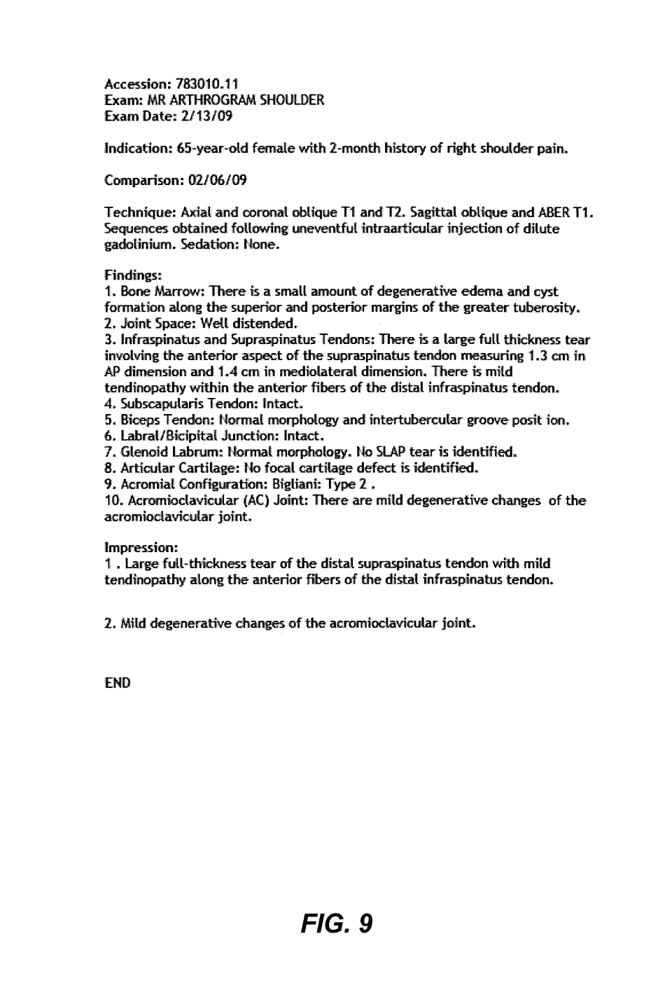

FIG. 9 illustrates a non-exhaustive example of a report included in an exam. The report corresponds to the image illustrated in FIG. 8 and is included in the same exam as the image in FIG. 8. The report indicates several ex-ante determinations, determined by the examiner at the time of examination. For instance, the report includes Findings 1-10. The report also includes Impressions 1-2. The ex-ante determinations indicated in the Findings and Impressions were determined by the examiner and are based at least on the image illustrated in FIG. 8. The report is anonymized and blinded. The subject of the report is anonymous and a reviewer is unable to determine if this report is included in an EOI or if the report is included in a foil exam. In some embodiments, the accession number may be a number based on at least a random process or a pseudo random process. In at least one embodiment, the exam date may be based on at least a random process or a pseudo random process. In at least one embodiment, the exam date may be based on a randomly determined offset.

The above specification, examples, and data provide a complete description of the composition, manufacture, and use of the invention. Since many embodiments of the invention can be made without departing from the spirit and scope of the invention, the invention resides in the claims hereinafter appended.

1. A method for reviewing exams with at least one computing device that performs actions, comprising:
modifying a plurality of exams to be anonymous, blinded and accessible as foil exams in a database;
modifying an exam of interest (EOI) to be anonymous and blinded;
selecting at least one foil exam based at least in part on the EOI;
generating an exam set that includes the at least one foil exam and the modified EOI;
providing the exam set to a reviewer, wherein based on the reviewer's review of the exam set, the reviewer provides assessment metrics that include a range of graded values for each exam in the exam set which correspond to whether a determination included in the at least one foil exam and another determination included in the modified EOI each have met a community standard which is based on a variability in a comparison of each range of other graded values that are provided by a plurality of different reviewers for each of the foil exams; and
generating, by the at least one computing device, a report for the exam set based on at least a quality of the assessment metrics provided by reviewer in comparison to the community standard.

2. The method of claim 1, wherein the at least one foil exam was previously reviewed by at least one other reviewer.

3. The method of claim 1, wherein the actions further comprise:
comparing each element of an assessment metric that corresponds to a foil exam to another element of another assessment metric that was previously provided by another reviewer of the foil exam; and
determining a consistency score for the review based on at least each comparison.

4. The method of claim 1, wherein the actions further comprise:
comparing an assessment metric that corresponds to a foil exam to another assessment metric that was previously provided by another reviewer of the foil exam; and
determining a consistency score for the review based on at least each comparison.

5. The method of claim 1, further comprising at least one of:
adding the modified EOI to the database as another accessible foil exam; and
providing to the reviewer a simulation of a data environment that was previously provided to an examiner for initially generating each exam.

6. The method of claim 1, further comprising at least one of:
tagging the at least one foil exam and the modified EOI with at least one identifier; and
annotating the at least one foil exam and the modified EOI.

7. The method of claim 1, further comprising employing the report in a legal dispute to perform at least one of:
determining a duty of care provided by a medical professional that initially generated the EOI; and
determining a competency of a medical professional to review a plurality of exams.

8. A network device for reviewing exams over a network, comprising:
a memory device that is arranged to store instructions;
a processor device that is arranged to execute instructions that perform actions, including:
modifying a plurality of exams to be anonymous, blinded and accessible as foil exams in a database;
modifying an exam of interest (EOI) to be anonymous and blinded;
selecting at least one foil exam based at least in part on the EOI;
generating an exam set that includes the at least one foil exam and the modified EOI;
providing the exam set to a reviewer, wherein based on the reviewer's review of the review set, the reviewer provides assessment metrics that include a range of graded values for each exam in the exam set which correspond to whether a determination included in the at least one foil exam and another determination included in the modified EOI each have met a community standard which is based on a variability in a comparison of each range of other graded values that are provided by a plurality of different reviewers for each of the foil exams; and
generating a report for the exam set based on at least a quality of the assessment metrics provided by the reviewer in comparison to the community standard.

9. The network device of claim 8, wherein the at least one foil exam was previously reviewed by at least one other reviewer.

10. The network device of claim 8, wherein the actions further comprise:
comparing each element of an assessment metric that corresponds to a foil exam to another element of another assessment metric that was previously provided by another reviewer of the foil exam; and
determining a consistency score for the review based on at least each comparison.

11. The network device of claim 8, wherein the actions further comprise:
comparing an assessment metric that corresponds to a foil exam to another assessment metric that was previously provided by another reviewer of the foil exam; and
determining a consistency score for the review based on at least each comparison.

12. The network device of claim 8, further comprising at least one of:
adding the modified EOI to the database as another accessible foil exam; and
providing to the reviewer a simulation of a data environment that was previously provided to an examiner for initially generating each exam.

13. The network device of claim 8, further comprising at least one of:
tagging the at least one foil exam and the modified EOI with at least one identifier; and
annotating the at least one foil exam and the modified EOI.

14. The network device of claim 8, further comprising employing the report in a legal dispute to perform at least one of:
determining a duty of care provided by a medical professional that initially generated the EOI; and
determining a competency of a medical professional to review a plurality of exams.

15. A system for reviewing exams over a network, comprising:
a server device that includes:
a memory device that stores instructions;
a processor device that executes instructions that perform actions, comprising:
modifying a plurality of exams to be anonymous, blinded and accessible as foil exams in a database;
modifying an exam of interest (EOI) to be anonymous and blinded;
selecting at least one foil exam based at least in part on the EOI;
generating an exam set that includes the at least one foil exam and the modified EOI; and
generating a report for the exam set based on at least assessment metrics provided by a reviewer; and
a client device that includes:
a memory device that stores instructions; and
a processor device that executes instructions that provides the exam set to that reviewer, wherein based on the reviewer's review of the exam set, the reviewer provides assessment metrics that include a range of graded values for each exam in the exam set which correspond to whether a determination included in the at least one foil exam and another determination included in the modified EOI each have met a community standard which is based on a variability in a comparison of each range of other graded values that are provided by a plurality of different reviewers for each of the foil exams.

16. The system of claim 15, wherein the at least one foil exam was previously reviewed by at least one other reviewer.

17. The system of claim 15, wherein the actions further comprise:
comparing each element of an assessment metric that corresponds to a foil exam to another element of another assessment metric that was previously provided by another reviewer of the foil exam; and
determining a consistency score for the review based on at least each comparison.

18. The system of claim 15, wherein the actions further comprise:
comparing an assessment metric that corresponds to a foil exam to another assessment metric that was previously provided by another reviewer of the foil exam; and
determining a consistency score for the review based on at least each comparison.

19. The system of claim 15, further comprising at least one of:
adding the modified EOI to the database as another accessible foil exam; and
providing to the reviewer a simulation of a data environment that was previously provided to an examiner for initially generating each exam.

20. The system of claim 15, further comprising at least one of:
tagging the at least one foil exam and the modified EOI with at least one identifier; and
annotating the at least one foil exam and the modified EOI.

21. The system of claim 15, further comprising employing the report in a legal dispute to perform at least one of:
determining a duty of care provided by a medical professional that initially generated the EOI; and
determining a competency of a medical professional to review a plurality of exams.

22. The method of claim 1, further comprising employing the report in an educational testing environment to perform at least one of:
determining a duty of care provided by a medical professional that initially generated the EOI in view of the community standard; and
determining a competency of a medical professional to review a plurality of exams.

23. The network device of claim 8, further comprising employing the report in an educational testing environment to perform at least one of:
determining a duty of care provided by a medical professional that initially generated the EOI in view of the community standard; and
determining a competency of a medical professional to review a plurality of exams.

24. The system of claim 15, further comprising employing the report in an educational testing environment to perform at least one of:
determining a duty of care provided by a medical professional that initially generated the EOI in view of the community standard; and
determining a competency of a medical professional to review a plurality of exams.
